(19) United States
(12) Patent Application Publication
(10) Pub. No.: US 2025/0058272 A1
(43) Pub. Date: Feb. 20, 2025

(54) CAPTURING CARBON DIOXIDE

(71) Applicant: Carbon Engineering ULC, Squamish (CA)

(72) Inventors: John Michael Repasky, New Braunfels, TX (US); Douglas Edward Olmstead, Squamish (CA); Megan Lynn O’Brien, Squamish (CA); Teresa Juliet Pena Bastidas, Squamish (CA); Todd Ernest Wilke, Squamish (CA)

(21) Appl. No.: 18/717,768

(22) PCT Filed: Dec. 7, 2022
(86) PCT No.: PCT/US2022/052175

§ 371 Date: Jun. 7, 2024

Related U.S. Application Data
(60) Provisional application No. 63/286,903, filed on Dec. 7, 2021.

(51) Int. Cl. B01D 53/18; B01D 53/14

(52) U.S. Cl. CPC B01D 53/185; B01D 53/1475; B01D 2257/504; B01D 2258/0283

(57) ABSTRACT

A perforated packing for capturing carbon dioxide (CO₂) from a dilute gas mixture includes at least one perforated mg) structure and a feed structure. The at least one perforated structure includes a body that includes at least one wall defining an inner volume of the body and an outer surface exposed to the dilute gas mixture; and a plurality of perforations extending through the at least one wall between the inner volume and the outer surface. The feed structure is fluidly coupled to the body and operable to flow a CO₂ capture solution into the inner volume of the body, through the plurality of perforations, and along the outer surface to form a liquid film of the CO₂ capture solution along at least part of the outer surface, the liquid film of the CO₂ capture solution configured to absorb CO2 from the dilute gas mixture.

### TECHNICAL FIELD

This disclosure describes systems, apparatus, and methods for capturing carbon dioxide.

### BACKGROUND

Capturing carbon dioxide (CO₂) from the atmosphere is one approach to mitigating greenhouse gas emissions and slowing climate change. However, many technologies designed for CO₂ capture from point sources of emissions, such as from flue gas of industrial facilities, are generally ineffective in capturing CO₂ from the atmosphere due to the significantly lower CO₂ concentrations and large volumes of atmospheric air required to process. In recent years, progress has been made in finding technologies better suited to capture CO₂ directly from the atmosphere. Some of these direct air capture (DAC) systems use a solid sorbent where an active agent is attached to a substrate. These DAC systems typically employ a cyclic adsorption-desorption process where, after the solid sorbent is saturated with CO₂, it releases the CO₂ using a humidity or thermal swing and is regenerated.

Other DAC systems use a liquid sorbent (sometimes referred to as a solvent) to capture CO₂ from the atmosphere. An example of such a DAC system would be one where a fan is used to draw air across a high surface area packing that is wetted with a solution comprising the liquid sorbent. CO₂ in the air reacts with the liquid sorbent to generate a CO₂ rich solution. The rich solution is processed to regenerate a lean solution and to release as a concentrated carbon stream, for example, CO, CO₂ or other carbon products.

### SUMMARY

In an example implementation, a system for capturing carbon dioxide from a dilute gas mixture includes one or more perforated structures each including an inner volume, an outer surface, and a plurality of perforations; and at least one feed structure fluidly coupled to the one or more perforated structures. The at least one feed structure is operable to flow a first fluid into the inner volume of the of one or more perforated structures; and the plurality of perforations of the one or more perforated structures are operable to flow the first fluid.

In an aspect combinable with the example implementation, the one or more perforated structures is coupled to the at least one feed structure at a nonparallel angle.

In another aspect combinable with any of the previous aspects, the one or more perforated structures is coupled to the at least one feed structure at a perpendicular angle.

In another aspect combinable with any of the previous aspects, the first fluid is operable to flow from a first perforated structure to a second perforated structure of the one or more perforated structures.

In another aspect combinable with any of the previous aspects, at least one perforation of the plurality of perforations is sized to have a diameter of less than 1.5 mm.

In another aspect combinable with any of the previous aspects, a first perforation of the plurality of perforations is spaced apart from a second perforation of the plurality of perforations by at least 0.5 mm.

In another aspect combinable with any of the previous aspects, a subset of the plurality of perforations are arranged to form at least a portion of a shape on the outer surface that includes a hexagon, square, rectangle, triangle, or circle.

In another aspect combinable with any of the previous aspects, the one or more perforated structures is spaced in an arrangement that is at least one of: hexagonal, square, rectangular, triangular, or circular.

In another aspect combinable with any of the previous aspects, the one or more perforated structures includes at least one of: tubes, plates, spheres, or blocks.

In another aspect combinable with any of the previous aspects, the one or more perforated structures includes a porous material.

In another aspect combinable with any of the previous aspects, the one or more perforated structures includes a plurality of microstructures including at least one of: ridges, dimples, pores, etches, granules, or fibers.

Another aspect combinable with any of the previous aspects further includes a basin positioned at least partially below the one or more perforated structures.

In another aspect combinable with any of the previous aspects, the one or more perforated structures is operable to contact the first fluid with a second fluid to yield a CO₂-lean gas.

In another aspect combinable with any of the previous aspects, the first fluid includes a CO₂ capture solution and the second fluid includes a CO₂-laden gas.

In another aspect combinable with any of the previous aspects, the plurality of perforations is operable to flow the CO₂ capture solution from the inner volume to the outer surface of the one or more perforated structures.

In another aspect combinable with any of the previous aspects, the CO₂ capture solution forms a liquid film on the outer surface of the one or more perforated structures.

In another example implementation, a method for capturing carbon dioxide from a dilute gas mixture includes flowing a first fluid through at least one feed structure that is fluidly coupled to one or more perforated structures, each of the one or more perforated structures including an inner volume, an outer surface, and a plurality of perforations; flowing the first fluid from the at least one feed structure into the inner volume of the of one or more perforated structures; and flowing the first fluid from the inner volume of the of one or more perforated structures through the plurality of perforations of the one or more perforated structures.

In an aspect combinable with the example implementation, the one or more perforated structures is coupled to the at least one feed structure at a nonparallel angle.

In another aspect combinable with any of the previous aspects, the one or more perforated structures is coupled to the at least one feed structure at a perpendicular angle.

Another aspect combinable with any of the previous aspects further includes flowing the first fluid from a first perforated structure to a second perforated structure of the one or more perforated structures.

In another aspect combinable with any of the previous aspects, at least one perforation of the plurality of perforations is sized to have a diameter of less than 1.5 mm.

In another aspect combinable with any of the previous aspects, a first perforation of the plurality of perforations is spaced apart from a second perforation of the plurality of perforations by at least 0.5 mm.

In another aspect combinable with any of the previous aspects, a subset of the plurality of perforations are arranged to form at least a portion of a shape on the outer surface that includes a hexagon, square, rectangle, triangle, or circle.

In another aspect combinable with any of the previous aspects, the one or more perforated structures is spaced in an arrangement that is at least one of: hexagonal, square, rectangular, triangular, or circular.

In another aspect combinable with any of the previous aspects, the one or more perforated structures includes at least one of: tubes, plates, spheres, or blocks.

In another aspect combinable with any of the previous aspects, the one or more perforated structures includes a porous material.

In another aspect combinable with any of the previous aspects, the one or more perforated structures includes a plurality of microstructures including at least one of: ridges, dimples, pores, etches, granules, or fibers.

Another aspect combinable with any of the previous aspects further includes catching a portion of the first fluid in a basin positioned at least partially below the one or more perforated structures.

Another aspect combinable with any of the previous aspects further includes flowing the first fluid into contact, via the one or more perforated structures, with a second fluid to yield a CO₂-lean gas.

In another aspect combinable with any of the previous aspects, the first fluid includes a CO₂ capture solution and the second fluid includes a CO₂-laden gas.

Another aspect combinable with any of the previous aspects further includes flowing the CO₂ capture solution from the inner volume to the outer surface of the one or more perforated structures.

In another aspect combinable with any of the previous aspects, the CO₂ capture solution forms a liquid film on the outer surface of the one or more perforated structures.

In another example implementation, a perforated packing for capturing carbon dioxide (CO₂) from a dilute gas mixture includes at least one perforated structure and a feed structure. The at least one perforated structure includes a body that includes at least one wall defining an inner volume of the body and an outer surface exposed to the dilute gas mixture; and a plurality of perforations extending through the at least one wall between the inner volume and the outer surface. The feed structure is fluidly coupled to the body and operable to flow a CO₂ capture solution into the inner volume of the body, through the plurality of perforations, and along the outer surface to form a liquid film of the CO₂ capture solution along at least part of the outer surface, the liquid film of the CO₂ capture solution configured to absorb CO₂ from the dilute gas mixture.

In an aspect combinable with the example implementation, the feed structure includes at least one feed conduit defining a feed conduit inner volume fluidly coupled to the body.

In another aspect combinable with any of the previous aspects, the at least one feed conduit includes at least one conduit opening, the feed conduit inner volume fluidly coupled to the inner volume of the body by the at least one conduit opening.

In another aspect combinable with any of the previous aspects, the body extends along a longitudinal axis, and the at least one feed conduit extends along a feed conduit axis transverse to the longitudinal axis.

In another aspect combinable with any of the previous aspects, the at least one perforated structure includes a plurality of perforated structures; and a body of each perforated structure of the plurality of perforated structures having an inlet fluidly coupled to the feed conduit inner volume, the inlets of the plurality of perforated structures spaced apart in a direction parallel to the feed conduit axis.

In another aspect combinable with any of the previous aspects, the plurality of perforations of each of the plurality of perforated structures are disposed beneath the inlet of the respective perforated structure.

In another aspect combinable with any of the previous aspects, the at least one feed conduit has a horizontal orientation, the at least one feed conduit including a plurality of feed conduit perforations extending through at least a lower portion of the at least one feed conduit.

In another aspect combinable with any of the previous aspects, the at least one feed conduit has a horizontal orientation, and the at least one perforated structure extends vertically downward from the at least one feed conduit.

In another aspect combinable with any of the previous aspects, the at least one feed conduit has a vertical orientation, the at least one perforated structure extending horizontally from the at least one feed conduit.

In another aspect combinable with any of the previous aspects, a distance between adjacent perforations of the plurality of perforations is greater than 2 times a diameter of each of the plurality of perforations and less than 10 times a diameter of each of the plurality of perforations.

In another aspect combinable with any of the previous aspects, the at least one perforated structure is coupled to the feed structure at a nonparallel angle.

In another aspect combinable with any of the previous aspects, the plurality of perforations are disposed along an entire length of the at least one wall.

In another aspect combinable with any of the previous aspects, each perforation of the plurality of perforations has a largest dimension of less than 1.5 mm.

In another aspect combinable with any of the previous aspects, at least some of the plurality of perforations are arranged on the at least one wall to form a shape including a hexagon, square, rectangle, triangle, or circle.

In another aspect combinable with any of the previous aspects, the at least one perforated structure includes a plurality of perforated structures, the plurality of perforated structures forming an arrangement that is at least one of a hexagonal arrangement, a square arrangement, a rectangular arrangement, a triangular arrangement, or a circular arrangement.

In another aspect combinable with any of the previous aspects, the body extends along a longitudinal axis; and a cross-sectional shape of the body defined in a plane perpendicular to the longitudinal axis is rounded.

In another aspect combinable with any of the previous aspects, the at least one perforated structure includes at least one of tubes, plates, spheres, or blocks.

In another aspect combinable with any of the previous aspects, the outer surface of the at least one wall is defined by a plurality of structures including at least one of ridges, dimples, pores, etches, granules, or fibers.

In another aspect combinable with any of the previous aspects, the outer surface of the at least one wall includes a hydrophilic surface.

In another aspect combinable with any of the previous aspects, the at least one perforated structure includes a plurality of perforated structures being spaced apart from one another to define a plurality of flow gaps for the dilute gas mixture between each body of the plurality of perforated structures.

In another aspect combinable with any of the previous aspects, the body of the at least one perforated structure is rigid.

In another aspect combinable with any of the previous aspects, the body of the at least one perforated structure is resilient.

In another example implementation, a gas-liquid contactor for capturing carbon dioxide (CO₂) from ambient air includes at least one inlet, at least one outlet spaced apart from the at least one inlet, at least one perforated packing disposed between the at least one inlet and the at least one outlet, one or more basins configured to hold a CO₂ capture solution, a fan, and a liquid distribution system. The at least one perforated packing includes a plurality of perforated structures spaced apart from each other. Each perforated structure of the plurality of perforated structures includes at least one wall defining an inner volume and an outer surface, and a plurality of perforations extending through the at least one wall. The one or more basins includes a bottom basin positioned at least partially below the at least one perforated packing. The fan is operable to flow the ambient air (1) in a flow direction from the at least one inlet to the at least one outlet and (2) along the outer surface of each of the plurality of perforated structures. The liquid distribution system is fluidly coupled to at least one of the plurality of perforated structures and operable to flow the CO₂ capture solution into the inner volume of at least one of the plurality of perforated structures, through the plurality of perforations of at least one of the plurality of perforated structures, and along the outer surface of at least one of the plurality of perforated structures, to form a liquid film of the CO₂ capture solution along at least part of the outer surface of the at least one of the plurality of perforated structures. The liquid film of the CO₂ capture solution is configured to absorb CO₂ from the ambient air.

In an aspect combinable with the example implementation, each perforated structure extends along a longitudinal axis transverse to the flow direction of the ambient air.

Another aspect combinable with any of the previous aspects further includes a housing defining an interior at least partially exposed to the ambient air and disposed between the at least one inlet and the at least one outlet, the plurality of perforated structures spaced apart within the interior and forming an arrangement of perforated structures that is at least one of a hexagonal arrangement, a square arrangement, a rectangular arrangement, a triangular arrangement, or a circular arrangement.

In another aspect combinable with any of the previous aspects, the arrangement of perforated structures includes a plurality of rows of perforated structures spaced apart in a direction parallel to the flow direction.

In another aspect combinable with any of the previous aspects, the arrangement of perforated structures has a depth measured in a direction parallel to the flow direction, the depth being between 2 meters and 10 meters.

In another aspect combinable with any of the previous aspects, the perforated packing includes a feed structure fluidly coupled to at least one of the plurality of perforated structures and operable to flow a CO₂ capture solution into the inner volume of the at least one of the plurality of perforated structures, through the plurality of perforations of the at least one of the plurality of perforated structures, and along the outer surface of the at least one of the plurality of perforated structures to form a liquid film of the CO₂ capture solution along at least part of the outer surface.

In an aspect combinable with the example implementation, the feed structure includes at least one feed conduit defining a feed conduit inner volume fluidly coupled to the at least one of the plurality of perforated structures.

In another aspect combinable with any of the previous aspects, the at least one feed conduit includes at least one conduit opening, the feed conduit inner volume fluidly coupled to the inner volume of the at least one of the plurality of perforated structures by the at least one conduit opening.

In another aspect combinable with any of the previous aspects, the body extends along a longitudinal axis, and the at least one feed conduit extends along a feed conduit axis transverse to the longitudinal axis.

In another aspect combinable with any of the previous aspects, a body of each perforated structure of the plurality of perforated structures has an inlet fluidly coupled to the feed conduit inner volume, the inlets of the plurality of perforated structures spaced apart in a direction parallel to the feed conduit axis.

In another aspect combinable with any of the previous aspects, the plurality of perforations of each of the plurality of perforated structures are disposed beneath the inlet of the respective perforated structure.

In another aspect combinable with any of the previous aspects, the at least one feed conduit has a horizontal orientation, the at least one feed conduit including a plurality of feed conduit perforations extending through at least a lower portion of the at least one feed conduit.

In another aspect combinable with any of the previous aspects, the at least one feed conduit has a horizontal orientation, and the at least one perforated structure of the plurality of perforated structures extends vertically downward from the at least one feed conduit.

In another aspect combinable with any of the previous aspects, the at least one feed conduit has a vertical orientation, the at least one perforated structure of the plurality of perforated structures extending horizontally from the at least one feed conduit.

In another aspect combinable with any of the previous aspects, a distance between adjacent perforations of the plurality of perforations of at least one of the plurality of perforated structures is greater than 2 times a diameter of each of the plurality of perforations and less than 10 times a diameter of each of the plurality of perforations.

In another aspect combinable with any of the previous aspects, at least one of the plurality of perforated structures is coupled to the feed structure at a nonparallel angle.

In another aspect combinable with any of the previous aspects, the plurality of perforations of at least one of the plurality of perforated structures are disposed along an entire length of the at least one wall.

In another aspect combinable with any of the previous aspects, each perforation of the plurality of perforations of at least one of the plurality of perforated structures has a largest dimension of less than 1.5 mm.

In another aspect combinable with any of the previous aspects, at least some of the plurality of perforations of at least one of the plurality of perforated structures are arranged on the at least one wall of the respective perforated structure to form a shape including a hexagon, square, rectangle, triangle, or circle.

In another aspect combinable with any of the previous aspects, the plurality of perforated structures form an arrangement that is at least one of a hexagonal arrangement, a square arrangement, a rectangular arrangement, a triangular arrangement, or a circular arrangement.

In another aspect combinable with any of the previous aspects, a body of at least one of the plurality of perforated structures extends along a longitudinal axis; and a cross-sectional shape of the body is defined in a plane perpendicular to the longitudinal axis is rounded.

In another aspect combinable with any of the previous aspects at least one of the plurality of perforated structures includes at least one of tubes, plates, spheres, or blocks.

In another aspect combinable with any of the previous aspects, the outer surface of the at least one wall of at least one of the plurality of perforated structures is defined by a plurality of structures including at least one of ridges, dimples, pores, etches, granules, or fibers.

In another aspect combinable with any of the previous aspects, the outer surface of the at least one wall of at least one of the plurality of perforated structures includes a hydrophilic surface.

In another aspect combinable with any of the previous aspects, the plurality of perforated structures are spaced apart from one another to define a plurality of flow gaps for the dilute gas mixture between each body of the plurality of perforated structures.

In another aspect combinable with any of the previous aspects, a body of at least one of the plurality of perforated structures is rigid.

In another aspect combinable with any of the previous aspects, a body of at least one of the plurality of perforated structures is resilient.

In another example implementation, a method for capturing carbon dioxide (CO2) from a dilute gas mixture includes flowing the dilute gas mixture between a plurality of perforated structures and along an outer surface of at least one of the plurality of perforated structures; and flowing a CO₂ capture solution within at least one of the plurality of perforated structures, through perforations of at least one of the plurality of perforated structures, and along the outer surface of at least one of the plurality of perforated structures to form a liquid film of the CO₂ capture solution along at least part of the outer surface of the at least one of the plurality of perforated structures and absorb the CO₂ from the dilute gas mixture into the liquid film of the CO₂ capture solution.

An aspect combinable with the example implementation further includes flowing the CO₂ capture solution through a feed structure along a first direction, wherein flowing the CO₂ capture solution within the at least one of the plurality of perforated structures includes flowing the CO₂ capture solution within the at least one of the plurality of perforated structures along a second direction that is transverse to the first direction.

In another aspect combinable with any of the previous aspects, flowing the CO₂ capture solution within the at least one of the plurality of perforated structures along the second direction includes flowing the CO₂ capture solution downwardly.

In another aspect combinable with any of the previous aspects, flowing the CO₂ capture solution within at least one of the plurality of perforated structures along the second direction includes flowing the CO₂ capture solution horizontally.

In another aspect combinable with any of the previous aspects, flowing the dilute gas mixture includes flowing the dilute gas mixture along a flow direction; and flowing the CO₂ capture solution within the at least one of the plurality of perforated structures includes flowing the CO₂ capture solution within the at least one of the plurality of perforated structures along a liquid direction that is transverse to the flow direction.

In another aspect combinable with any of the previous aspects, the perforations of the at least one of the plurality of perforated structures are disposed along an entire length of the respective perforated structure.

In another aspect combinable with any of the previous aspects, the outer surface of the at least one of the plurality of perforated structures includes at least one of ridges, dimples, pores, etches, granules, or fibers.

In another aspect combinable with any of the previous aspects, flowing the CO₂ capture solution along the outer surface of the at least one of the plurality of perforated structures includes flowing the CO₂ capture solution along a hydrophilic outer surface of the at least one of the plurality of perforated structures.

In another aspect combinable with any of the previous aspects, the plurality of perforated structures includes one or more resilient perforated structures.

In another aspect combinable with any of the previous aspects, flowing the CO₂ capture solution within the at least one of the plurality of perforated structures includes filling an entirety of the at least one of the plurality of perforated structures with the CO₂ capture solution.

In another aspect combinable with any of the previous aspects, flowing the CO₂ capture solution includes flowing the CO₂ capture solution having a density at a reference temperature greater than a density of water at the reference temperature.

In another aspect combinable with any of the previous aspects, flowing the CO₂ capture solution includes flowing the CO₂ capture solution at liquid loading rates greater than 0.5 L/m²s and less than 10 L/m²s.

In another example implementation, a direct air capture (DAC) system for capturing carbon dioxide (CO₂) from ambient air includes an air contactor and a regeneration system. The air contactor includes a housing, at least one perforated packing, one or more basins configured to hold a CO₂ capture solution, a fan, and a liquid distribution system. The housing defines an interior and includes at least one inlet and at least one outlet. The at least one perforated packing is disposed in the housing between the at least one inlet and the at least one outlet, the at least one perforated packing includes a plurality of perforated structures being spaced apart. Each perforated structure of the plurality of perforated structures includes at least one wall defining an inner volume and an outer surface; and a plurality of perforations extending through the at least one wall. The one or more basins include a bottom basin positioned at least partially below the at least one perforated packing. The fan is operable to circulate the ambient air (1) in a flow direction from the at one least inlet to the at least one outlet and (2) along the outer surface of each of the plurality of perforated structures. The liquid distribution system is fluidly coupled to at least one of the plurality of perforated structures and operable to flow the CO₂ capture solution into the inner volume of at least one of the plurality of perforated structures, through the plurality of perforations of at least one of the plurality of perforated structures, and along the outer surface of at least one of the plurality of perforated structures to form a liquid film of the CO₂ capture solution along at least part of the outer surface of the at least one of the plurality of perforated structures, the liquid film of the CO₂ capture solution configured to absorb CO₂ from the ambient air. The regeneration system is in fluid communication with the liquid distribution system to receive the CO₂ capture solution from the air contactor, the regeneration system configured to regenerate the CO₂ capture solution and form a CO₂-lean liquid to return to the air contactor.

In an aspect combinable with the example implementation, each perforated structure extends along a longitudinal axis transverse to the flow direction of the ambient air.

Another aspect combinable with any of the previous aspects further includes a housing defining an interior at least partially exposed to the ambient air and disposed between the at least one inlet and the at least one outlet, the plurality of perforated structures spaced apart within the interior and forming an arrangement of perforated structures that is at least one of a hexagonal arrangement, a square arrangement, a rectangular arrangement, a triangular arrangement, or a circular arrangement.

In another aspect combinable with any of the previous aspects, the arrangement of perforated structures includes a plurality of rows of perforated structures spaced apart in a direction parallel to the flow direction.

In another aspect combinable with any of the previous aspects, the arrangement of perforated structures has a depth measured in a direction parallel to the flow direction, the depth being between 2 meters and 10 meters.

In another aspect combinable with any of the previous aspects, the perforated packing includes a feed structure fluidly coupled to at least one of the plurality of perforated structures and operable to flow a CO₂ capture solution into the inner volume of the at least one of the plurality of perforated structures, through the plurality of perforations of the at least one of the plurality of perforated structures, and along the outer surface of the at least one of the plurality of perforated structures to form a liquid film of the CO₂ capture solution along at least part of the outer surface.

In an aspect combinable with the example implementation, the feed structure includes at least one feed conduit defining a feed conduit inner volume fluidly coupled to the at least one of the plurality of perforated structures.

In another aspect combinable with any of the previous aspects, the at least one feed conduit includes at least one conduit opening, the feed conduit inner volume fluidly coupled to the inner volume of the at least one of the plurality of perforated structures by the at least one conduit opening.

In another aspect combinable with any of the previous aspects, the body extends along a longitudinal axis, and the at least one feed conduit extends along a feed conduit axis transverse to the longitudinal axis.

In another aspect combinable with any of the previous aspects, a body of each perforated structure of the plurality of perforated structures has an inlet fluidly coupled to the feed conduit inner volume, the inlets of the plurality of perforated structures spaced apart in a direction parallel to the feed conduit axis.

In another aspect combinable with any of the previous aspects, the plurality of perforations of each of the plurality of perforated structures are disposed beneath the inlet of the respective perforated structure.

In another aspect combinable with any of the previous aspects, the at least one feed conduit has a horizontal orientation, the at least one feed conduit including a plurality of feed conduit perforations extending through at least a lower portion of the at least one feed conduit.

In another aspect combinable with any of the previous aspects, the at least one feed conduit has a horizontal orientation, and the at least one perforated structure of the plurality of perforated structures extends vertically downward from the at least one feed conduit.

In another aspect combinable with any of the previous aspects, the at least one feed conduit has a vertical orientation, the at least one perforated structure of the plurality of perforated structures extending horizontally from the at least one feed conduit.

In another aspect combinable with any of the previous aspects, a distance between adjacent perforations of the plurality of perforations of at least one of the plurality of perforated structures is greater than 2 times a diameter of each of the plurality of perforations and less than 10 times a diameter of each of the plurality of perforations.

In another aspect combinable with any of the previous aspects, at least one of the plurality of perforated structures is coupled to the feed structure at a nonparallel angle.

In another aspect combinable with any of the previous aspects, the plurality of perforations of at least one of the plurality of perforated structures are disposed along an entire length of the at least one wall.

In another aspect combinable with any of the previous aspects, each perforation of the plurality of perforations of at least one of the plurality of perforated structures has a largest dimension of less than 1.5 mm.

In another aspect combinable with any of the previous aspects, at least some of the plurality of perforations of at least one of the plurality of perforated structures are arranged on the at least one wall of the respective perforated structure to form a shape including a hexagon, square, rectangle, triangle, or circle.

In another aspect combinable with any of the previous aspects, the plurality of perforated structures form an arrangement that is at least one of a hexagonal arrangement, a square arrangement, a rectangular arrangement, a triangular arrangement, or a circular arrangement.

In another aspect combinable with any of the previous aspects, a body of at least one of the plurality of perforated structures extends along a longitudinal axis; and a cross-sectional shape of the body is defined in a plane perpendicular to the longitudinal axis is rounded.

In another aspect combinable with any of the previous aspects at least one of the plurality of perforated structures includes at least one of tubes, plates, spheres, or blocks.

In another aspect combinable with any of the previous aspects, the outer surface of the at least one wall of at least one of the plurality of perforated structures is defined by a plurality of structures including at least one of ridges, dimples, pores, etches, granules, or fibers.

In another aspect combinable with any of the previous aspects, the outer surface of the at least one wall of at least one of the plurality of perforated structures includes a hydrophilic surface.

In another aspect combinable with any of the previous aspects, the plurality of perforated structures are spaced apart from one another to define a plurality of flow gaps for the dilute gas mixture between each body of the plurality of perforated structures.

In another aspect combinable with any of the previous aspects, a body of at least one of the plurality of perforated structures is rigid.

In another aspect combinable with any of the previous aspects, a body of at least one of the plurality of perforated structures is resilient.

In an example implementation, a perforated packing for capturing carbon dioxide (CO2) from a dilute gas mixture includes: at least one perforated structure including a body having at least one wall defining an inner volume of the body, the at least one wall defining an inner surface and an outer surface; and a plurality of perforations extending through the at least one wall between the inner surface and the outer surface; and a feed structure fluidly coupled to the body and operable to flow a CO₂ capture solution through the plurality of perforations to form a liquid film of the CO₂ capture solution along at least part of the inner surface, the liquid film of the CO₂ capture solution configured to absorb CO₂ from the dilute gas mixture.

Implementations of systems and methods for capturing carbon dioxide according to the present disclosure may include one, some, or all of the following features For example, packing with the features described in this invention are designed specifically for commercial DAC applications and as such have the ability to reduce at least one of air volume, packing depth, liquid flow, and air contactor footprint without significant sacrifice to CO₂ uptake performance. Design criteria of DAC packing that reflect good performance include: low static pressure design, ability to distribute liquid evenly throughout fill height, low fouling capabilities, increase in air contacting efficiency, lower material requirements, efficiency effects of larger pack sizes, and manufacturability.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example gas-liquid contactor.

FIG. 2A shows another example gas-liquid contactor.

FIG. 2B shows another example gas-liquid contactor.

FIG. 3 shows another example gas-liquid contactor.

FIG. 4 shows an example feature of perforated packing for the gas-liquid contactor of the present disclosure.

FIG. 5 shows an example perforated packing for the gas-liquid contactor of the present disclosure.

FIG. 6 shows an example perforated packing for the gas-liquid contactor of the present disclosure.

FIG. 7 shows an example perforated packing for the gas-liquid contactor of the present disclosure.

FIG. 8 shows an example perforated packing for the gas-liquid contactor of the present disclosure.

FIG. 9 shows an example perforated packing for the gas-liquid contactor of the present disclosure.

FIG. 10 shows an example perforated packing for the gas-liquid contactor of the present disclosure.

FIG. 11 shows an example perforated packing for the gas-liquid contactor of the present disclosure.

FIG. 12 shows an example perforated packing for the gas-liquid contactor of the present disclosure.

FIG. 13 shows an example perforated packing for the gas-liquid contactor of the present disclosure.

FIG. 14A shows an example feature of a perforated packing for the gas-liquid contactor of the present disclosure.

FIG. 14B is a schematic showing a contact angle between a liquid and a surface.

FIG. 14C is a schematic showing apparent and actual contact angles between a liquid and a surface.

FIG. 14D is an enlarged view of the circled portion of the feature of FIG. 14A.

FIG. 14E is an enlarged view of the circled portion of the feature of FIG. 14A.

FIG. 14F is an enlarged view of the circled portion of the feature of FIG. 14A.

FIG. 15 is a schematic illustration of a direct air capture system having the gas-liquid contactor disclosed herein.

FIG. 16 is a schematic flow diagram of a method for capturing carbon dioxide (CO₂) from a dilute gas mixture.

FIG. 17 is a schematic diagram of a control system (or controller) for a gas-liquid contactor of the present disclosure.

### DETAILED DESCRIPTION

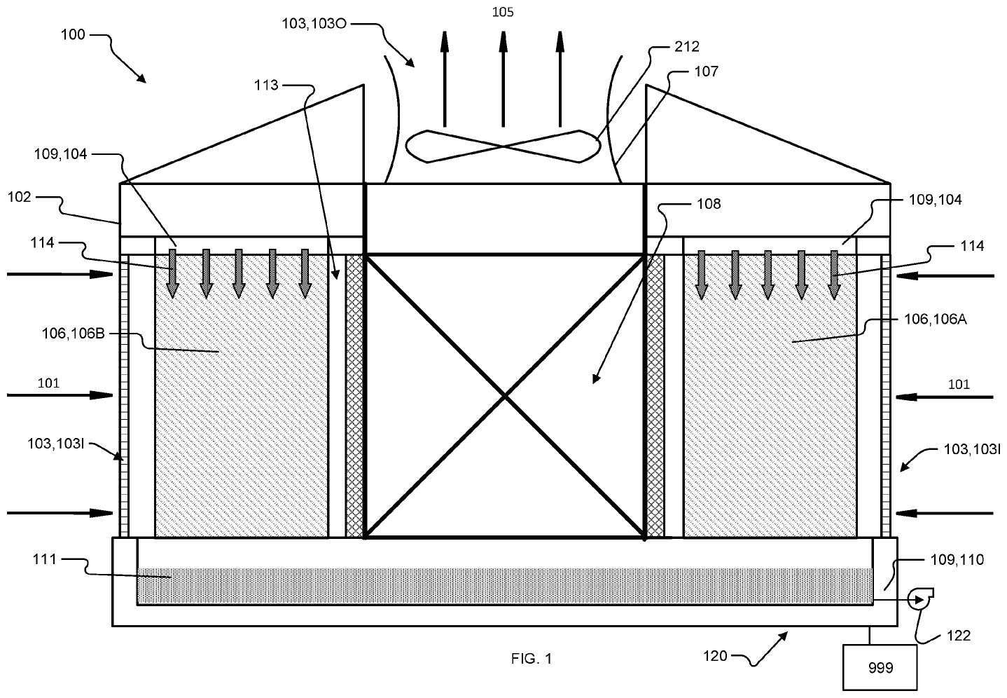

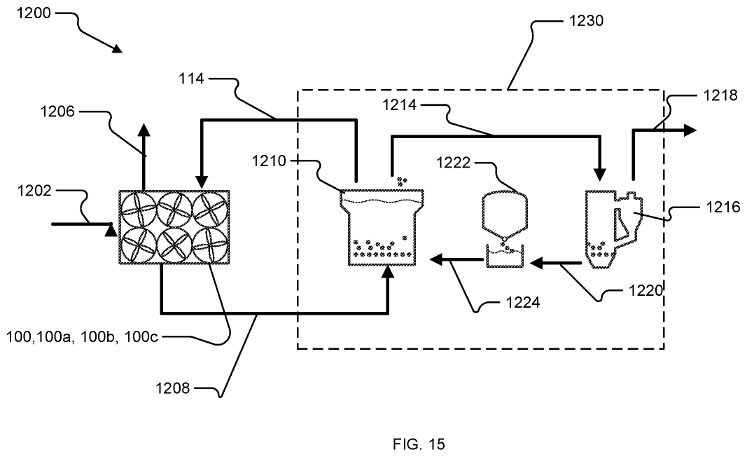

Referring to FIG. 1, the present disclosure describes systems and methods for capturing carbon dioxide (CO2) with a gas-liquid contactor 100, from the atmosphere (i.e., ambient or atmospheric air) or from another fluid source that contains dilute concentrations of CO2. Concentrations of CO₂ in the atmosphere are dilute, in that they are presently in the range of 400-420 parts per million (“ppm”) or approximately 0.04-0.042% v/v, and less than 1% v/v. These atmospheric concentrations of CO₂ are at least one order of magnitude lower than the concentration of CO₂ in point-source emissions, such as flue gases, where point-source emissions can have concentrations of CO₂ ranging from 5-15% v/v depending on the source of emissions. In some implementations, the gas-liquid contactor 100 is operated to capture the dilute CO₂ present in ambient air by ingesting the ambient air as a flow of CO₂-laden air 101, and by treating the CO₂-laden air 101 so as to transfer CO₂ present therein to a CO₂ capture solution 114 (e.g. a CO₂ sorbent) via absorption. Some or all of the CO₂ in the CO₂-laden air 101 is removed, and the treated CO₂-laden air 101 is then discharged by the gas-liquid contactor 100 as a flow of CO₂-lean gas 105 (or, CO₂-low air). In operating to treat atmospheric air in this manner, the gas-liquid contactor 100 may sometimes be referred to herein as an “air contactor” because it facilitates absorption of CO₂ from the atmospheric air into the CO₂ capture solution 114. In contrast to water cooling towers which function primarily to transfer heat between water and atmospheric air, the gas-liquid contactor 100 functions primarily to achieve mass transfer of CO₂ from the atmospheric air to the CO₂ capture solution 114. In operating in this manner, the gas-liquid contactor 100 may be used as part of a direct air capture (DAC) system 1200, described in greater detail below in reference to FIG. 15.

In some implementations, and referring to FIG. 1, the CO₂ capture solution 114 is a caustic solution. In some implementations, the CO₂ capture solution 114 has a pH of 10 or higher. In some implementations, the CO₂ capture solution 114 has a pH of approximately 14. Non-limiting examples of the CO₂ capture solution 114 include aqueous alkaline solutions (e.g., KOH, NaOH, or a combination thereof), aqueous amino acid salt solutions, non-aqueous solutions of amines, aqueous carbonate and/or bicarbonate solutions, phenoxides/phenoxide salts, ionic liquids, non-aqueous solvents, or a combination thereof. In some cases, the CO₂ capture solution 114 may include promoters and/or additives that increase the rate of CO₂ uptake. Non-limiting examples of promoters include carbonic anhydrase, amines (primary, secondary, tertiary), and boric acid. Non-limiting examples of additives include chlorides, sulfates, acetates, phosphates, surfactants.

In some implementations, at a given reference temperature, the density of the CO₂ capture solution 114 is greater than the density of water at the same reference temperature. At comparable reference temperatures, in some implementations, the density of the CO₂ capture solution 114 is at least 10% greater than the density of water. In some implementations, at comparable reference temperatures, the density of the CO₂ capture solution 114 is approximately 10% greater than the density of water. The density and the viscosity of the CO₂ capture solution 114 can vary depending on the composition of the CO₂ capture solution 114 and the temperature. For example, at temperatures of 20° C. to 0° C., the CO₂ capture solution 114 or a CO₂-laden capture solution 111 (see below) may comprise 1 M KOH and 0.5 M K₂CO₃ and may have a density ranging from 1115-1119 kg/m³ and a viscosity ranging from 1.3-2.3 mPa-s. In another example, at temperatures of 20° C. to 0° C., the CO₂ capture solution 114 or the CO₂-laden capture solution 111 may comprise 2 M KOH and 1 M K₂CO₃, and may have a density ranging from 1260-1266 kg/m³ and a viscosity ranging from 1.8-3.1 mPa-s. In comparison, water has a density of 998 kg/m³ and viscosity of 1 mPa-s at 20° C.

In some implementations, and referring to FIG. 1, CO₂ from the CO₂-laden air 101 is captured by contacting the CO₂-laden air 101 with the CO₂ capture solution 114 in the gas-liquid contactor 100. Reacting the CO₂ from the CO₂-laden air 101 with an alkaline CO₂ capture solution 114 (for example) can form a CO₂-laden capture solution 111. In the configuration where the CO₂ capture solution 114 comprises an alkali hydroxide, CO₂ is absorbed by reacting with the alkali hydroxide to form a carbonate-rich capture solution (e.g., K₂CO₃, Na₂CO₃, or a combination thereof). The CO₂-laden capture solution 111 can include the carbonate-rich capture solution and is thus sometimes referred to herein as the “carbonate-rich capture solution 111”. The CO₂-laden capture solution 111 can be processed to recover the captured CO₂ for downstream use and to regenerate the alkali hydroxide for use in the CO₂ capture solution 114. In some instances, recovered CO₂ can be delivered downhole and sequestered in a geological formation, subsurface reservoir, carbon sink, or the like. In some instances, the recovered CO₂ may be used for enhanced oil recovery by injecting the recovered CO₂ into one or more wellbores to enhance production of hydrocarbons from a reservoir. In some implementations, recovered CO₂ can be fed to a downstream fuel synthesis system, which can include a syngas generation reactor.

The CO₂-laden capture solution 111 can also include other components in smaller amounts, such as hydroxide ions, alkali metal hydroxide (e.g., KOH, NaOH), water, and impurities. For example, the carbonate-rich capture solution 111 can comprise between 0.4 M to 6 M K₂CO₃ and between 1 M to 10 M KOH. In another implementation, the carbonate-rich capture solution 111 can comprise an aqueous Na₂CO₃-NaOH mixture. In some implementations, the carbonate-rich capture solution 111 can comprise a mixture of K₂CO₃ and Na₂CO₃.

The capture kinetics of capturing CO₂ from the CO₂-laden air 101 to form carbonate may be improved by the introduction of an additive such as a promoter species in the CO₂ capture solution 114. Non-limiting examples of promoters for boosting CO₂ capture with carbonate include carbonic anhydrase, amines (primary, secondary, tertiary), zwitterionic amino acids, and boric acid. The resulting carbonate-rich capture solution 111 produced by the gas-liquid contactor 100 includes carbonates and bicarbonates and includes the promoter as well. An example composition of such a carbonate-rich capture solution 111 may include K₂CO₃/KHCO₃ and a promoter. The carbonate-rich capture solution 111 resulting from such a CO₂ capture solution 114 may have a pH in the range of 11-13 and may have little residual hydroxide from the CO₂ capture solution 114. In some cases, additives that are not considered promoters can be used to improve the uptake of CO₂ in the CO₂ capture solution 114.

Referring to FIG. 1, the gas-liquid contactor 100 includes a housing 102. The housing 102 defines part of the corpus of the gas-liquid contactor 100 and provides structure thereto. The housing 102 includes exterior structure or walls that partially enclose any combination of interconnected structural members. The interconnected structural members provide structural support and stability to the gas-liquid contactor 100, and provide a body for supporting components of the gas-liquid contactor 100 within the housing 102. The interconnected structural members can include, but are not limited to, walls, panels, beams, frames, etc. The housing 102 may include other components as well, such as cladding, panels, etc. which help to close off parts of the housing 102 and define the enclosure of the housing 102. The housing 102 at least partially encloses and defines an interior 113 of the housing 102. The interior 113 of the housing 102 is an inner volume or inner space in which components of the gas-liquid contactor 100 are positioned. The housing 102 also includes openings 103 that allow for movement of gases into and out of the gas-liquid contactor 100. For example, and referring to FIG. 1, the housing 102 has one or more inlet(s) 1031. In the implementation of FIG. 1, the one or more inlet(s) 1031 are formed by the openings 103, such that the inlet(s) 1031 may be referred to herein as one or more inlet opening(s) 1031 through which the CO₂-laden air 101 enters the interior 113 of the housing 102. The housing 102 has one or more outlet(s) 1030. In the implementation of FIG. 1, the one or more outlet(s) 1030 are formed by the openings 103, such that the outlet(s) 1030 may be referred to herein as one or more outlet opening(s) 1030 through which the CO₂-lean gas 105 exits the interior 113 of the housing 102. In the example implementation of the gas-liquid contactor 100 of FIG. 1, the housing 102 defines two inlets 1031 and one outlet 1030. The outlet 1030 may be defined by a component of the gas-liquid contactor 100. For example, in the implementation of the gas-liquid contactor 100 of FIG. 1, the gas-liquid contactor 100 has a fan stack 107 with an upright orientation. The fan stack 107 helps to discharge the CO₂-lean gas 105, and the outlet 1030 is positioned along the fan stack 107. In such an implementation, the CO₂-laden air 101 enters the interior 113 of the housing 102 along a substantially horizontal direction through one or both of the inlets 1031, and the CO₂-lean gas 105 exits the interior 113 along a substantially vertical direction through the outlet 1030. The outlet 1030 is located at the upper extremity of the fan stack 107. In implementations of the gas-liquid contactor 100 without a fan stack 107, the outlet 1030 may be located elsewhere. Other configurations for the inlets and outlets 1031,1030 of the housing 102 are possible.

The housing 102 at least partially encloses and protects components of the gas-liquid contactor 100 positioned in the interior 113 of the housing 102. One example of such a component is one or more packings 106, which are protected from the surrounding atmosphere by the housing 102. As can be seen in FIG. 1, one or more packings 106, which are sometimes referred to herein collectively as “fill 106” or “packing 106”, are located within the interior 113 in a position adjacent to the one or more inlets 1031. In this position, the one or more packings 106 receive the CO₂-laden air 101 which enters the interior 113 via the one or more inlets 1031. The one or more packings 106 function to increase transfer of CO₂ present in the CO₂-laden air 101 to a flow of the capture solution 114, in that the one or more packings 106 provide a large surface area for the capture solution 114 to disperse on, thereby increasing the reactive area between the CO₂-laden air 101 and the capture solution 114. The capture solution 114 transforms the CO₂-laden air 101 into the CO₂-lean gas 105 which is discharged from the one or more outlet(s) 1030 of the gas-liquid contactor 100. The packing 106 receives the CO₂ capture solution 114 and facilitates absorption of the CO₂ present in the CO₂-laden air 101 into the CO₂ capture solution 114 on the packing 106, as described in greater detail below.

Referring to FIG. 1, one possible arrangement of the packing 106 includes two or more packing sections 106A, 106B. Each packing section 106A, 106B is positioned adjacent to and downstream of one of the inlets 1031. The packing sections 106A, 106B are spaced apart from each other within the housing 102. The direction along which the packing sections 106A, 106B are spaced apart is parallel to the direction along which the CO₂-laden air 101 flows through the packing sections 106A, 106B. The space or volume defined between the packing sections 106A, 106B and/or one or more structural members of the housing 102 is a plenum 108. The plenum 108 is flanked by the packing sections 106A, 106B. The plenum 108 is a void or space within the housing 102 into which gases flow downstream of the packing sections 106A, 106B (e.g., the CO₂-lean gas 105), and from which the CO₂-lean gas 105 flows out of the housing 102 through the outlet 1030. The plenum 108 is part of the interior 113 of the housing 102. The volume of the plenum 108 is less than a volume of the interior 113. In some implementations, the volume of the interior 113 of the housing 102 is approximately equal to the combined volume of the packing sections 106A, 106B and the plenum 108. Referring to FIG. 1, the packing 106 is positioned along the same level, or is positioned along the same horizontal lower plane, as the plenum 108. After the CO₂-laden air 101 flows through the packing sections 106A, 106B, the CO₂-lean gas 105 flows through the plenum 108 before being discharged to the ambient environment. In other implementations of the gas-liquid contactor 100, the plenum is absent, as described in greater detail below.

In the example implementation of the gas-liquid contactor 100 of FIG. 1, the CO₂-laden air 101 enters the interior 113 of the housing 102 along a substantially horizontal direction through both of the inlets 1031. The CO₂-laden air 101 then flows through the packing sections 106A, 106B along a substantially horizontal direction, where the CO₂ present in the CO₂-laden air 101 contacts the CO₂ capture solution 114 present on the packing sections 106A, 106B and/or flowing in a substantially downward direction over the packing sections 106A, 106B. The CO₂ is absorbed by the CO₂ capture solution 114 to form the CO₂-laden capture solution 111. The CO₂-laden capture solution 111 flows downwardly off the packing sections 106A, 106B, and the CO₂-laden air 101 treated by the packing sections 106A, 106B exits the packing sections 106A, 106B as the CO₂-lean gas 105. The CO₂-lean gas 105 from both packing sections 106A, 106B converges in the plenum 108, and then flows in a vertically upward direction out of the plenum 108 through the outlet 1030.

In the example implementation of the packing 106 of FIG. 1, each packing section 106A, 106B has a respective packing section height that are substantially equal to a height of the housing 102. In some implementations, the height of the packing sections 106A, 106B is substantially equal to a height of the inlets 1031. Providing the packing 106 with substantially the same height as the height of the housing 102 and the height of the inlets 1031 may help to prevent or reduce the ability of the CO₂-laden air 101 to bypass the packing 106 (e.g., flow around the packing 106), thereby helping to ensure that the greatest possible volume of CO₂-laden air 101 is treated by the packing 106. By “substantially equal” or “substantially the same”, it is understood that the heights are approximately equal in value, with any differences being minimal compared to the overall height dimension, where said differences may result from manufacturing tolerances, packing installation requirements, and/or adjustments in dimensions to allow for seals, baffles or other features. Other configurations for the packing 106 are possible. For example, in another implementation, the heights of the packing sections 106A, 106B are less than the height of the housing 102, and any gaps between the packing sections 106A, 106B and the housing 102 are sealed using suitable techniques.

The packing 106 may be made of any suitable material, or have any suitable configuration, to achieve the function ascribed to the packing 106 herein. Some or all of the packing 106 may be made from PVC, which is relatively light, moldable, affordable, and resists degradation caused by many chemicals. The packing 106 is arranged, constructed, treated or otherwise configured to promote spreading of the liquid CO₂ capture solution 114 into a thin film on the surfaces of the packing 106, which may enable maximum exposure of the liquid CO₂ capture solution 114 to the CO₂ present in the CO₂-laden air 101, as explained in greater detail below. Such “film-type” packing fill is generally more compatible with DAC systems since they have the capacity for more effective mass transfer per unit volume of fill space. For example, film-type fill offers a relatively high specific surface area-to-volume ratio (“specific surface area” in m²/m³). A high specific surface area is not only important for exposure of CO₂ to the surface of the CO2 capture solution 114, but it also has cost and structural implications. The packing 106 may define an air travel depth (e.g., packing depth), which represents the distance traversed by the CO₂-laden air 101 as it flows through the packing 106. The air travel depth may be in the range of 2-10 meters. The packing 106 may be vertically sectioned, or include multiple packing sections positioned one above another with minimal spacing or vertical gaps therebetween. Each packing section 106A, 106B may include multiple packing portions arranged above one another and/or positioned within minimal separation along the air travel depth.

Referring to FIG. 1, the gas-liquid contactor 100 has, includes components of, or is functionally linked to, a liquid distribution system 120. The liquid distribution system 120 operates to move, collect and distribute the CO₂ capture solution 114 and/or the CO₂-laden capture solution 111 to the packing 106 as described herein. At least some of the features of the liquid distribution system 120 are supported by the housing 102. In the example implementation of FIG. 1, the support provided by the housing 102 includes structural support, in that components of the liquid distribution system 120 are structurally supported by the housing 102 so that loads generated by these components are supported by the structural members of the housing 102. Some or all of the features of the liquid distribution system 120 may be part of the gas-liquid contactor 100, or part of a DAC system 1200 (see FIG. 15).

Referring to FIG. 1, the liquid distribution system 120 includes one or more basins 109. Each basin 109 is a reservoir configured to receive one or both of the CO₂ capture solution 114 and the CO₂-laden capture solution 111 and to hold a volume thereof, thereby serving as a source of the CO₂ capture solution 114 and/or of the CO₂-laden capture solution 111. Each basin 109 may have any configuration or be made of any material suitable to achieve the function ascribed to it in the present description. For example, one or more of the basin(s) 109 may be open-topped, or partially or fully covered.

The basins 109 of the liquid distribution system 120 include one or more top basins 104 and one or more bottom basins 110. The top basins 104 are supported by the housing 102. In some implementations, the top basins are formed from portions of the housing 102. The top basins 104 are configured to at least partially enclose or store the CO₂ capture solution 114. Referring to FIG. 1, the top basins 104 are each positioned at least partially above the packing 106. Referring to FIG. 1, the top basins 104 are positioned above the interior 113, in particular above the inlets 1031. When stored (at least transiently) within the top basins 104, the CO₂ capture solution 114 is positioned to be circulated (e.g., through pumping or gravity flow or both) downwards, through the packing 106 and eventually into the bottom basin 110. As the CO₂ capture solution 114 is circulated through the packing 106, the CO₂-laden air 101 is circulated through the packing 106 to contact the CO₂ capture solution 114, through the plenum 108, and to an ambient environment as the CO₂-lean gas 105. A process stream is formed by contacting the CO₂-laden air 101 and the liquid CO₂ capture solution 114, where the process stream is or includes the CO₂-laden capture solution 111 having CO₂ absorbed from the CO₂-laden air 101 by the CO₂ capture solution 114. The top basins 104 may each have any suitable form or feature for distributing the CO₂ capture solution 114 over the packing 106. In the example implementation of the gas-liquid contactor 100 of FIG. 1, the basins 109 include two top basins 104. Each top basin 104 is positioned above one of the packing sections 106A, 106B to distribute the CO₂ capture solution 114 to the respective packing section 106A, 106B. The top basins 104 of FIG. 1 are fluidly isolated from one another (e.g., no fluid communication between the two top basins 104). Other configurations and numbers of the top basins 104 are possible.

Referring to FIG. 1, the one or more bottom basins 110 are positioned at the bottom of the gas-liquid contactor 100 opposite the top basins 104. As can be seen in FIG. 1, the bottom basin 110 is positioned below the packing 106 and below the housing 102. In particular, the bottom basin 110 is positioned below the interior 113. The bottom basin 110 acts as a collection tank for the process stream (e.g. the CO₂-laden capture solution 111). The CO₂-laden capture solution 111 including absorbed CO₂, as well as unreacted CO₂ capture solution 114, collects in the bottom basin 110, and may then be pumped or otherwise moved out of the bottom basin 110 for further processing. For example, at least a portion of the liquids collected in the bottom basin 110 may be processed and then pumped for redistribution over the packing 106 for use in CO₂ capture. In another possible implementation, some or all of the liquids collected in the bottom basin 110 is pumped to the top basins 104 without being processed, for redistribution over the packing 106 for CO₂ capture. The bottom basin 110 can be compatible with a containment structure and prevent loss of various CO₂ capture solutions 114, many of which have corrosive, caustic or high pH properties. In some aspects, the bottom basin 110 can be lined or coated with one or more materials that are resistant to caustic induced corrosion or degradation. In some implementations of the gas-liquid contactor 100, components can be kept out of the bottom basin 110 holding the CO₂ capture solution 114. Additionally, the gas-liquid contactor 100 can be designed to keep most or all the structural components out of the wettable area of the gas-liquid contactor 100, e.g., any portion of the gas-liquid contactor 100 that is in contact with the CO₂ capture solution 114. Examples of wettable areas of the gas-liquid contactor 100 includes components supporting the packing 106. FIG. 1 depicts a single bottom basin 110. However, other configurations and numbers of bottom basins 110 are possible.

Referring to FIG. 1, the CO₂ capture solution 114 flows over the packing 106 in a direction that is substantially perpendicular or transverse to the average direction along which the CO₂-laden air 101 circulates through the packing 106, also known as a “cross flow” configuration. In another possible implementation, the CO₂ capture solution 114 flows over the packing 106 in a direction that is opposite to the average direction along which the CO₂-laden air 101 circulates through the packing 106, also known as a “counter flow” configuration. In another possible implementation, the CO₂ capture solution 114 flows over the packing 106 in a direction that is parallel with the direction along which the CO₂-laden air 101 circulates through the packing 106, also known as a “cocurrent flow” configuration. In another possible configuration, the CO₂ capture solution 114 flows over the packing 106 according to a configuration that is a combination of one or more of cross flow, counter flow and cocurrent flow configurations.

The gas-liquid contactor 100 may include supports positioned within the packing 106 between the top basins 104 and bottom basin 110. For example, the packing 106 can include additional support for a specific portion of the packing 106, such as for an upper portion of the packing 106, so that the loads (e.g. the weight of the portion of packing 106 when dry plus the weight of the liquid hold up of the CO₂ capture solution 114 on the portion of the packing 106) do not bear upon another portion of the packing 106 (e.g. a bottom portion of the packing 106). In some aspects, the packing 106 may not include the support. The basins 109 may include one or more redistribution basin(s) positioned at a location between the top and bottom of the packing 106 (for example, between the top basin 104 and the bottom basin 110) to re-distribute the CO₂ capture solution 114 over the remaining packing sections. In example aspects, the redistribution basin can be positioned in the packing 106. The redistribution basin can divide the packing 106 into at least a top section and a bottom section. The CO₂ capture solution 114 can be pumped into this redistribution basin from the bottom basin 110. Alternatively, the CO₂ capture solution 114 that is distributed over a top packing section from the top basin 104 could be collected in the redistribution basin, and then distributed onto a bottom packing section positioned underneath the redistribution basin. In some aspects, at least one structural support can be positioned between the packing sections of packing 106.

The liquid distribution system 120 may include any suitable componentry, such as piping, weir(s), pump(s), valve(s), manifold(s), etc., fluidly coupled in any suitable arrangement, to achieve the functionality ascribed to the liquid distribution system 120 herein. One non-limiting example of such componentry is one or more pump(s) 122, an example of which is shown in FIG. 1. The pumps 122 function to move liquids under pressure, such as the CO₂ capture solution 114 or the CO₂-laden capture solution 111, from their source to where they are used. Some non-limiting examples of such functions of the pumps 122 include moving the CO₂ capture solution 114 to the top basins 104, and moving the CO₂ capture solution 114 and/or the CO₂-laden capture solution 111 from the bottom basin 110 for processing or redistribution over the packing 106. The pumps 122 may thus be used to move liquid to, from and within the gas-liquid contactor 100.

A control system (e.g., control system 999 shown in FIG. 1) may be used to control the flow of fluid by the pumps 122 of the liquid distribution system 120. For example, a control system can be used to control the pumps 122 in order to pump the CO₂ capture solution 114 from the bottom basin 110 to the top basins 104. The pumps 122 can also be controlled such that a constant velocity of flow is provided to the liquid distribution system 120 regardless of changes of liquid flow throughout the gas-liquid contactor 100.

The pumps 122 may help to distribute the CO₂ capture solution 114 over the packing 106 at relatively low liquid flow rates, which may help to reduce costs associated with pumping or moving the CO₂ capture solution 114. Further, low liquid flow rates of the CO₂ capture solution 114 over the packing 106 may result in a lower pressure drop of the CO₂-laden air 101 as it flows through the packing 106, which reduces the energy requirements of the device used for moving the CO₂-laden air 101 across the packing 106 (e.g. a fan 212 described below). The pumps 122 may be configured to generate intermittent or pulsed flow of the CO₂ capture solution 114 over the packing 106, which may allow for intermittent wetting of the packing 106 using relatively low liquid flows. The CO₂ capture solution 114 sprayed, flowed, or otherwise distributed over the packing 106 is collected in the bottom basin 110 and may then be moved by the pumps 122 back to the top basin 104, or sent downstream for processing.

The liquid process streams in the gas-liquid contactor 100, as well as process streams within any downstream processes with which the gas-liquid contactor 100 is fluidly coupled, can be flowed using one or more flow control systems (e.g., control system 999). A flow control system can include one or more flow pumps (including or in addition to the pumps 122), fans, blowers, or solids conveyors to move the process streams, one or more flow pipes through which the process streams are flowed and one or more valves to regulate the flow of streams through the pipes. Each of the configurations described herein can include at least one variable frequency drive (VFD) coupled to a respective pump that is capable of controlling at least one liquid flow rate. In some implementations, liquid flow rates are controlled by at least one flow control valve.

In some embodiments, a flow control system can be operated manually. For example, an operator can set a flow rate for each pump or transfer device and set valve open or close positions to regulate the flow of the process streams through the pipes in the flow control system. Once the operator has set the flow rates and the valve open or close positions for all flow control systems distributed across the system, the flow control system can flow the streams under constant flow conditions, for example, constant volumetric rate or other flow conditions. To change the flow conditions, the operator can manually operate the flow control system, for example, by changing the pump flow rate or the valve open or close position.

In some embodiments, a flow control system can be operated automatically. For example, the flow control system can be connected to a computer or control system (e.g., control system 999) to operate the flow control system. The control system can include a computer-readable medium storing instructions (such as flow control instructions and other instructions) executable by one or more processors to perform operations (such as flow control operations). An operator can set the flow rates and the valve open or close positions for all flow control systems distributed across the facility using the control system. In such embodiments, the operator can manually change the flow conditions by providing inputs through the control system. Also, in such embodiments, the control system can automatically (that is, without manual intervention) control one or more of the flow control systems, for example, using feedback systems connected to the control system. For example, a sensor (such as a pressure sensor, temperature sensor or other sensor) can be connected to a pipe through which a process stream flows. The sensor can monitor and provide a flow condition (such as a pressure, temperature, or other flow condition) of the process stream to the control system. In response to the flow condition exceeding a threshold (such as a threshold pressure value, a threshold temperature value, or other threshold value), the control system can automatically perform operations. For example, if the pressure or temperature in the pipe exceeds the threshold pressure value or the threshold temperature value, respectively, the control system can provide a signal to the pump to decrease a flow rate, a signal to open a valve to relieve the pressure, a signal to shut down process stream flow, or other signals.

The gas-liquid contactor 100 has a gas-circulating device which functions to move or circulate gas flows into and out of the gas-liquid contactor 100. In the implementation of the gas-liquid contactor of FIG. 1, the gas-circulating device of the gas-liquid contactor 100 is a fan 212. The fan 212 functions to circulate gases like ambient air, such that the CO₂-laden air 101 is caused by the fan 212 to flow into the gas-liquid contactor 100, and such that the CO₂-lean gas 105 is caused by the fan 212 to be discharged from the gas-liquid contactor 100. The fan 212 thus functions to circulate the CO₂-laden air 101 and the CO₂-lean gas 105 in the manner described herein. Referring to FIG. 1, the fan 212 is rotatable about a fan axis defined by a fan shaft. In the implementation of the fan 212 depicted in FIG. 1, the fan axis has an upright or vertical orientation. Other orientations for the shaft and for the fan axis are possible, as described in greater detail below. Referring to FIG. 1, the fan 212 is positioned upstream of the end of the fan stack 107 that defines the outlet 1030 and functions to induce a flow of the CO₂-lean gas 105 through the outlet 1030. In another possible configuration, the fan 212 is positioned elsewhere between the vertically-opposite ends of the fan stack 107 and upstream of the outlet 1030, such that the fan 212 flows the CO₂-lean gas 105 through the outlet 1030. Rotation of the fan 212 about the fan axis causes gases to circulate into the inlets 1031 and through the gas-liquid contactor 100. For example, in the implementation of the gas-liquid contactor of FIG. 1, rotation of the fan 212 causes the CO₂-laden air 101 to be drawn into the gas-liquid contactor 100, and causes the CO₂-lean gas 105 to be discharged from the gas-liquid contactor 100.

Other configurations of the gas-liquid contactor 100 are possible, some of which are now described in greater detail.

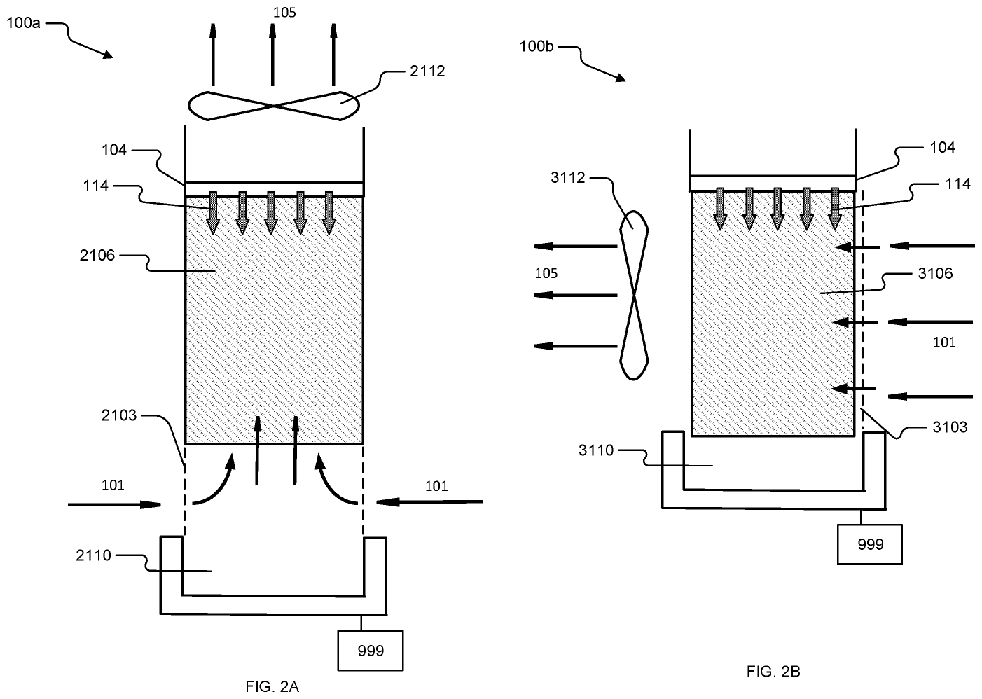

Referring to FIG. 2A, the gas-liquid contactor 100a can have an upright body and an air inlet 2103 along a bottom portion through which the CO₂-laden air 101 is admitted into the gas-liquid contactor 100a. The fan 2112 rotates to draw the CO₂-laden air 101 through the inlet 2110 in an upward direction to contact the packing section 2106. In the configuration of FIG. 2A, the gas-liquid contactor 100a has only one packing section 2106 and may therefore be referred to as a “single cell” gas-liquid contactor 100a. The CO₂ capture solution 114 circulates downwards by, for example, gravity flow, uniform or laminar flow, etc., within the packing 2106 and eventually flows into one or more bottom basins 2110. As the CO₂ capture solution 114 circulates through and over the packing 2106, the CO₂-laden air 101 is flowing (e.g., by action of the fan 2112) upwardly through the packing 2106 to contact the CO₂ capture solution 114. Thus, the flow of CO₂ capture solution 114 through the packing 2106 in FIG. 2A is counter-current (or counterflow) to the flow of the CO₂-laden air 101 through the packing 2106. A portion of the CO₂ within the CO₂-laden air 101 is transferred to (e.g., absorbed by) the CO₂ capture solution 114, and the fan 2112 moves the CO₂ lean gas 105 out of the gas-liquid contactor 100a to an ambient environment. The CO₂ rich solution flows into the at least one bottom basin 2110.

Referring to FIG. 2B, the gas-liquid contactor 100b has an upright body and an inlet 3103 along an upright side portion through which the CO₂-laden air 101 is admitted into the gas-liquid contactor 100b. The fan 3112 rotates about a horizontal fan axis to draw the CO₂-laden air 101 through the inlet 3103 in a substantially horizontal direction to contact the section of packing 3106. In the configuration of FIG. 2B, the gas-liquid contactor 100b has only one section of packing 3106 and may therefore be referred to as a “single cell” gas-liquid contactor 100b. The CO₂ capture solution 114 circulates downwards by, for example, gravity flow, uniform or laminar flow, etc., within the packing 3106 and eventually flows into one or more bottom basins 3110. As the CO₂ capture solution 114 circulates through the packing 3106, the CO₂-laden air 101 is flowing (e.g., by action of the fan 3112) substantially horizontally through the packing 3106 to thereby contact the CO₂ capture solution 114. Thus, the flow of CO₂ capture solution 114 through the packing 3106 in FIG. 2B is substantially perpendicular to the flow of the CO₂-laden air 101 through the packing 3106. Such a configuration of the flows may be referred to as a “cross flow” configuration. A portion of the CO₂ within the CO₂-laden air 101 is transferred to the CO₂ capture solution 114, and the fan 3112 moves the CO₂-lean gas 105 out of the gas-liquid contactor 100b to an ambient environment. The CO₂ rich solution flows into the at least one bottom basin 3110.

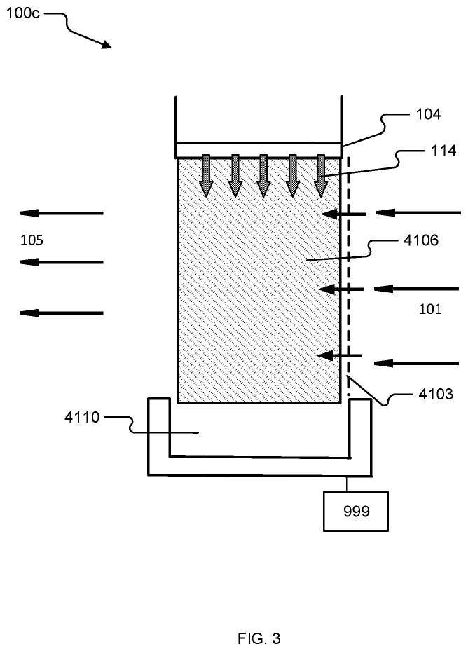

Referring to FIG. 3, the gas-liquid contactor 100c has an upright body and an inlet 4103 along an upright side portion through which the CO₂-laden air 101 is admitted into the gas-liquid contactor 100c. The gas-liquid contactor 100c of FIG. 3 has no fan or other gas-flowing device. The gas-liquid contactor 100c is exposed to a prevailing wind direction, such that atmospheric air (including the CO₂-laden air 101) is blown through the inlet 4103 in a substantially horizontal direction to contact the section of packing 4106. In the configuration of FIG. 3, the gas-liquid contactor 100c has only one section of packing 4106 and may therefore be referred to as a “single cell” gas-liquid contactor 100c. The CO₂ capture solution 114 circulates downwards by, for example, gravity flow, uniform or laminar flow, etc., within the packing 4106 and eventually flows into one or more bottom basins 4110. As the CO₂ capture solution 114 circulates through the packing 4106, the CO₂-laden air 101 is blown by the wind substantially horizontally through the packing 4106 to thereby contact the CO₂ capture solution 114. Thus, the flow of CO₂ capture solution 114 through the packing 4106 in FIG. 3 is substantially perpendicular to the flow of the CO₂-laden air 101 through the packing 4106. Such a configuration of the flows may be referred to as a “cross flow” configuration. A portion of the CO₂ within the CO₂-laden air 101 is transferred to the CO₂ capture solution 114, and the CO₂-lean gas 105 is blown out of the gas-liquid contactor 100c to an ambient environment. The CO₂ rich solution flows into the at least one bottom basin 4110. Thus, in at least the configuration of the gas-liquid contactor 100c of FIG. 3, a fan or other gas-flowing device is not required to circulate gas flows through the packing 4106. The description and one, some, or all of the advantages, and functions of features of the gas-liquid contactor 100 of FIG. 1 that are shown in FIGS. 2A to 3 apply mutatis mutandis to the features of FIGS. 2A to 3.

Different configurations of the packing 106, 2106, 3106, 4106 are possible for the gas-liquid contactors 100, 100a, 100b, 100c disclosed herein. One example of the packing 106, 2106, 3106, 4106 includes, or is, perforated packing. Perforated packing can include perforated structures that allow the CO₂ capture solution 114 to flow (e.g., seep) through perforations in the perforated structures and form a liquid film on the surface of the packing 106, 2106, 3106, 4106. The liquid film of CO₂ capture solution 114 can contact the CO₂-laden air 101 to yield the CO₂-lean gas 105. Perforated packing can facilitate wetting of the packing surface by allowing the CO₂ capture solution 114 to seep through the perforations so that droplets can coalesce to form a liquid film on a surface of the packing 106, 2106, 3106, 4106 exposed to the CO₂-laden air 101, where the liquid film is maintained by surface tension.

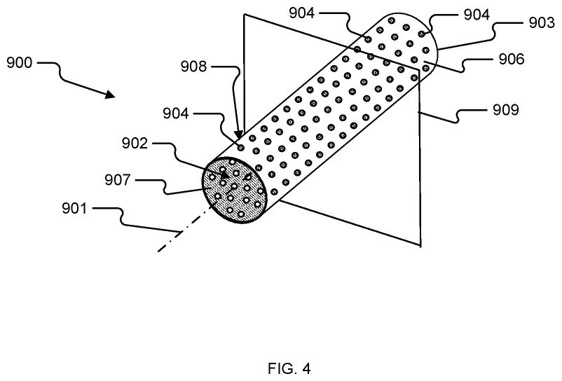

FIG. 4 shows an example perforated structure 900 that can be used in a perforated packing configuration to capture CO₂ from the CO₂-laden air 101, in any one of the gas-liquid contactors 100, 100a, 100b, 100c disclosed herein. The perforated structure 900 includes a body 908 that defines part of the corpus of the perforated structure 900 and provides structure thereto. The perforated structure 900 is elongated, in that the body 908 extends along a longitudinal axis 901. The length of the body 908, defined along the longitudinal axis 901, is greater than any other dimension of the body (e.g. width, diameter, thickness, etc.). Stated differently, the body 908 is longer than it is wide. The perforated structure 900 is partially or fully hollow, in that the body 908 has one or more walls 903 that define an inner volume 902 of the body 908. The one or more walls 903 may have any configuration, to define an inner volume 902 of any shape or size. For example, in the configuration of the perforated structure 900 of FIG. 4, the body 908 has one tubular wall 903 to form a cylindrical or tubular perforated structure 900, where the wall 903 delimits and circumscribes a cylindrical inner volume 902. In FIG. 4, the perforated structure 900 may be in the form of a perforated pipe. In other rounded or non-rounded configurations of the perforated structure 900, examples of which are described in greater detail below, the body 908 has multiple walls 903 defining any desired shape for the inner volume 902. Irrespective of the shape of the wall 903 or of the number of walls 903, the wall 903 forms a partial barrier to the exchange of fluids between the inner volume 902 and the surrounding environment (e.g., the flow of the CO₂-laden air 101).

Referring to FIG. 4, the cross-sectional shape of the body 908 (and thus of the perforated structure 900) may be defined relative to a plane 909 of the body 908 which is perpendicular to the longitudinal axis 901. The cross-sectional shape of the body 908 lies in the plane 909, and is circular in FIG. 4. In other implementations, the cross-sectional shape may be regular or irregular, and polygonal. The perforated structure 900 may have a cross-sectional shape that varies along its length or along another dimension. An example of a perforated structure 900 whose cross-sectional shape varies along its length is a tapered perforated structure 900, in which the area of the cross-sectional shape increases or decreases along the length of the perforated structure 900. Another example of a cross-sectional shape of the perforated structure 900 is one formed by the wall 903 having an irregular form defining multiple points, peaks, valleys or other variations. The perforated structure 900 is shown in FIG. 4 as being a revolute body defined about the longitudinal axis 901. In other implementations, the shape of the perforated structure 900 is not defined relative to a longitudinal axis. For example, the perforated structure 900 may be in the form of a panel which is perforated on one or more of the planar walls. In another example, the perforated structure 900 may be a block. Other possible and non-limiting shapes or forms for the perforated structure 900 include tubes, plates, and spheres. It will be appreciated that the perforated structure 900 may have any suitable shape or form.

Referring to FIG. 4, the wall 903 defines one or more outer surfaces 906. The outer surface 906 faces the external environment of the perforated structure 900, and thus forms some or all of the outermost surface of the perforated structure 900. The wall 903 includes an inner surface 907 facing the inner volume 902 of the body 908. A thickness of the wall 903 may be defined as the distance between the outer surface 906 and the inner surface 907. The outer surface 906 is exposed to the CO₂-laden air 101 flowing around the perforated structure 900, as described in greater detail below. The shape, size, texture, number and configuration of the outer surface 906 of the perforated structure 900 may vary, and is a function of the configuration of the wall 903. The outer surface 906 may be defined by structures of, or on, the wall 903, as explained in greater detail below.

The perforated structure 900 includes multiple perforations 904. Each perforation 904 is an aperture or through-hole extending through the wall 903, between the inner surface 907 and the outer surface 906. The perforations 904 individually and collectively allow for the exchange of fluid (e.g. gas and liquid) between the inner volume 902 and the environment surrounding the perforated structure 900. The perforations 904 are sized and arranged to allow the CO₂ capture solution 114 to seep from the inner volume 902 to the outer surface 906 so that a liquid film of the CO₂ capture solution 114 is formed on the outer surface 906. The perforations 904 can be sized, arranged, and/or shaped to facilitate forming the liquid film. In implementations where the perforations are round (e.g. circular or elliptical), the perforations 904 can be sized to have diameters in the range of less than 0.1 mm to 10 mm. In implementations where the perforations are round, the perforations 904 can be sized to have diameters in the range of 0.5 mm to 5 mm. For example, perforations 904 that have a diameter of about 1 mm can form the liquid film. In some implementations, the perforations 904 have varying diameters, in that a first group of the perforations 904 has a first diameter, and at least one other group of the perforations 904 has a second diameter different from the first diameter. The perforations 904 can have other shapes as well. Non-limiting examples of different shapes for the perforations 904 include regular and irregular shapes and polygonal shapes (e.g. triangular, square, pentagon, etc.). For such different shapes of the perforations 904, the largest dimension (e.g. width) of a given perforation 904 may be in the range of 0.1 mm to 10 mm.

The perforations 904 can be spaced apart to facilitate forming the liquid film. Perforation spacing can be characterized by pitch (e.g., center-to-center hole spacing). In implementations where the perforations are round, the pitch can be in the range of 1.0 to 10 times the perforation diameter. In implementations where the perforations are round, the pitch can be in the range of 1.25 to 5 times the perforation diameter. In implementations where the perforations are round, the pitch can be in the range of 2 to 10 times the perforation diameter. For example, the perforations 904 can be spaced apart from one another by at least 0.5 mm to facilitate forming the liquid film. In some implementations, the perforations 904 can be spaced apart from one another in a latticed arrangement. For example, the perforations 904 can be spaced hexagonally, squarely, or a combination thereof.

Effective spacing of the perforations 904 can depend on multiple factors including the size of the perforations 904, the orientation or arrangement of the perforated structure 900, maintaining the structural integrity of the material used for the perforated structure 900, surface tension and viscosity of the CO₂ capture solution 114, or pressure drops and velocities of the gas/liquid phases. In some implementations, the perforations 904 can be sized or spaced on the order of less than the characteristic dimension of typical liquid droplets to enable formation of the liquid film of CO₂ capture solution 114. For example, the perforations 904 can be sized or spaced to increase wetted surface area via capillary action or surface tension of the CO₂ capture solution 114. In some implementations, the perforations 904 can be sized or spaced on the order of more than the characteristic dimension of typical liquid droplets to enable film breakage and droplet dispersion. In some implementations, the perforated structure 900 can further include other structures which form part of the outer surface 906, as explained in greater detail below. These structures, along with the perforations 904, may enable formation of the liquid film of CO₂ capture solution 114.

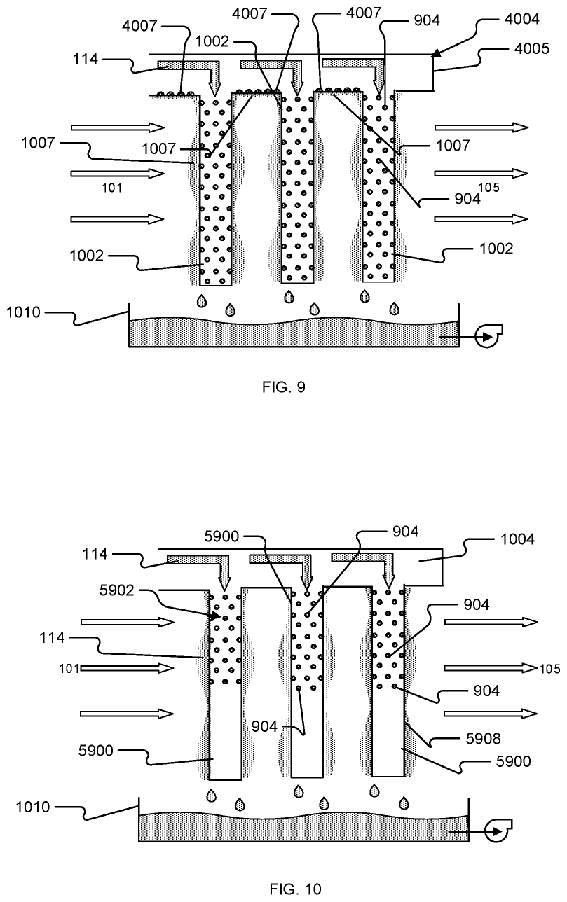

The number, pattern/arrangement and extent of the perforations 904 of a given perforated structure 900 can vary. For example, in the implementation of the perforated structure 900 of FIG. 4, the perforations 904 are disposed along the entire length of the wall 903, such that the entirety of the perforated structure 900 is perforated. In other possible implementations, an example of which is shown in FIG. 10, the perforated structures 5900 are only partially perforated along their length, in that the perforations 904 are present along only some of the length of the body 5908. The perforated structures 5900 have an upright orientation and are only perforated along an upper portion of their bodies 5908. In such a configuration of the perforated structure 5900, the CO₂ capture solution 114 is configured to flow into the inner volume 5902 and seep through the perforations 904 on the upper portion of the body 5908. This forms a liquid film of CO₂ capture solution 114 along the upper portion of the body 5908, and the liquid film flows from the upper portion to the lower unperforated portion of the body 5908 because of gravity, such that the liquid film of CO₂ capture solution 114 can be formed along the entire length of the perforated structure 5900. In another possible implementation of a perforated structure, the perforations 904 are present only in perforated segments of the perforated structure, where the perforated segments are adjacent to, and alternate with, non-perforated segments of the perforated structure. The perforations 904 may be arranged on the outer wall 903 to form a pattern or a shape. The pattern or shape may include the following non-limiting examples: a hexagon, a square, a rectangle, a triangle, or a circle. Any suitable configuration of the perforations 904 is possible, and the configuration of perforations may be selected based on the size of the perforations 904, the orientation or arrangement of the perforated structure 900, maintaining the structural integrity of the material used for the perforated structure 900, surface tension and viscosity of the CO₂ capture solution 114, or pressure drops and velocities of the gas/liquid phases. Similarly, the configuration of perforations 904 can vary within a single perforated structure, and they can be equally or unequally spaced apart, in order to achieve the desired flow of liquid film of CO₂ capture solution 114 along the outer surface 906.

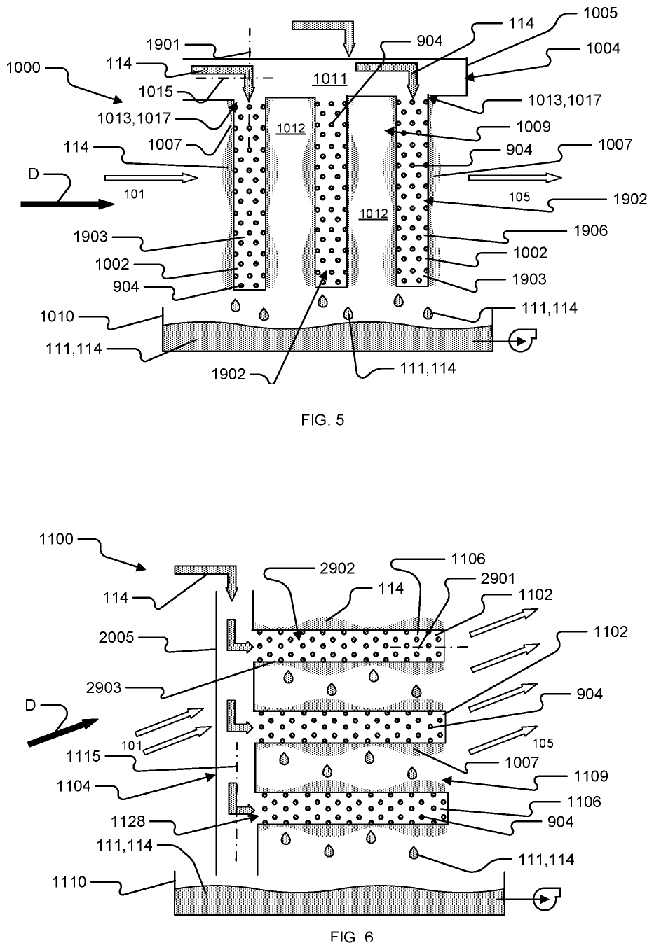

FIG. 5 shows an example of a perforated packing 1000, which can make up some or all of the packing 106, 2106, 3106, 4106 used in the gas-liquid contactors 100, 100a, 100b, 100c disclosed herein. The perforated packing 1000 of FIG. 5 includes multiple perforated structures 1002.

Referring to FIG. 5, the perforated structures 1002 are spaced apart from each other and form an arrangement 1009 of perforated structures 1002. In FIG. 5, the perforated structures 1002 are spaced apart in a direction that is parallel to the flow direction, D, of the CO₂-laden air 101 flowing through the perforated packing 1000. The perforated structures 1002 may also be spaced apart from each other in other directions, such as in a direction that is transverse to the flow direction, D (i.e., perpendicular to the page of FIG. 5). Each perforated structure 1002 has its own outer wall 1903 which is a separate structure from the outer wall 1903 of adjacent perforated structures 1002. Each perforated structure 1002 has its own perforations 904 which are separate from the perforations 904 of adjacent perforated structures 1002. The perforated packing 1000 has flow gaps 1012 defined between adjacent perforated structures 1002. The flow gaps 1012 make up a portion of the volume of the interior 113 in which the perforated packing 1000 is located, and are in fluid communication with the plenum 108. The CO₂-laden air 101 flows through the flow gaps 1012 and between the perforated structures 1002, thereby permitting the CO₂ in the CO₂-laden air 101 to be absorbed by the liquid film 1007 of CO2 capture solution 114 on the outer surfaces 1906 of the perforated structures 1002.

Referring to the perforated packing 1000 of FIG. 5, the perforated structures 1002 are oriented vertically. This orientation of the perforated structures 1002 allows the CO₂ capture solution 114 to fill each perforated structure 1002. In steady state operation of the perforated packing 1000, the perforated structures 1002 are filled with the CO₂ capture solution 114 and generating the liquid film 1007 along the outer surfaces 1906. In initial, start-up or pulsed-flow operation of the perforated packing 1000, the perforated structures 1002 are filled with the CO₂ capture solution 114 simultaneously, sequentially or a combination of both. The vertical orientation of the perforated structures 1002 allows the liquid film 1007 of CO₂ capture solution 114 to flow downwardly along the outer surfaces 1906 of the perforated structures 1002 because of gravity. The perforated structures 1002 are thus oriented so that the average flow direction of the CO₂ capture solution 114 is along the longitudinal axes 1901 of the perforated structures 1002.

Referring to FIG. 5, the perforated packing 1000 includes one or more feed structures 1004. The feed structure 1004 is fluidly coupled to the perforated structures 1002 so that the CO₂ capture solution 114 can flow from the feed structure 1004 to the inner volume 1902 of each perforated structure 1002. When the CO₂ capture solution 114 is flowing through the perforated packing 1000, the feed structure 1004 is operable to flow (e.g., through pumping or gravity flow or both) the CO₂ capture solution 114 through the body 1903 of each perforated structure 1002 and through its perforations 904. The CO₂ capture solution 114 is thus caused to seep out of the inner volume 1902 through the perforations 904 and onto the outer surfaces 1906 of the perforated structures 1002. The feed structure 1004 is in fluid communication with one or more features of the liquid distribution system 120, such as one or more of the basins 109, pipes, and pump(s) 122 to receive the CO₂ capture solution 114 before flowing the CO₂ capture solution 114 to the perforated structures 1002.

The CO₂ capture solution 114 then forms the liquid film 1007 of CO₂ capture solution 114 on the outer surfaces 1906. The fluid dynamics which cause the formation of the liquid film 1007 may vary. For example, in one possible configuration, the liquid film 1007 begins to form as droplets of CO₂ capture solution 114 emerge from the perforations 904 on the outer surfaces 1906 and begin to coalesce into the liquid film 1007. The liquid film 1007 remains substantially static (e.g., does not flow along the outer surfaces 1906) until the accumulation of CO₂ capture solution 114 into the liquid film 1007 is sufficient to allow the CO₂ capture solution 114 to flow along the outer surfaces 1906. The flowing CO₂ capture solution 114 is maintained as the liquid film 1007 because of the surface tension of the outer surfaces 1906. In the configuration of the vertically-oriented perforated structures 1002 of FIG. 5, the liquid film 1007 flows downwardly along the outer surfaces 1906 of the perforated structures 1002 because of gravity. The liquid film 1007 in implementations is continuous along an extent of the outer surface 1906 of a given perforated structure 1002, in that the liquid film 1007 is uninterrupted along said extent. In other possible implementations, the liquid film 1007 is discontinuous along an extent of the outer surface 1906 of a given perforated structure 1002, in that there may be portions of said extent on which the liquid film 1007 is not present.

The exposed surface of the liquid film 1007 is a gas-liquid interface between the CO₂-laden air 101 flowing between the outer surfaces 1906 and the CO₂ capture solution 114. CO₂ from the CO₂-laden air 101 is absorbed into the liquid film 1007 to form the CO₂-laden capture solution 111 and the CO₂-lean gas 105. The CO₂-lean gas 105 is discharged from the perforated packing 1000, and the CO₂-laden capture solution 111 may be included in a mixed solution with unreacted CO₂ capture solution 114. The solution of CO₂ capture solution 114 and CO₂-laden capture solution 111 flows along the outer surfaces 1906 (in a downward direction in FIG. 5) as the liquid film 1007. The liquid film 1007 eventually breaks at the lower extremity of the perforated structures 1002, and forms droplets of solution that are collected in the bottom basin 1010. From the bottom basin 1010, the solution can be processed as described above. The liquid film 1007 may have any suitable properties, which may be similar to those of the CO₂ capture solution 114 described above. The thickness of the liquid film 1007 may vary along the extent of the perforated structure 1002.

The perforated structures disclosed herein (for example, perforated structures 900, 1002) therefore allow for the formation of a liquid film 1007 of CO₂ capture solution 114. The perforated packing disclosed herein (for example, perforated packing 1000) thus facilitates wetting of the packing surface by allowing the CO₂ capture solution 114 to seep through the perforations so that droplets can coalesce to form a liquid film 1007 that is maintained by surface tension. The perforated packing disclosed herein (for example, perforated packing 1000) allows for the formation of the liquid film 1007 on all packing surfaces regardless of the orientation of the perforated structured because the CO₂ capture solution 114 seeps from within to without via the perforations. The perforated packing disclosed herein may thus be suitable for increasing the effective mass transfer of CO₂ from the ambient air to the CO₂ capture solution 114 over most if not all of the surface area of the perforated packing, because of the formation of the continuous liquid film 1007.

The feed structure 1004 may have different configurations to achieve the functionality ascribed to it herein. For example, and referring to FIG. 5, the feed structure 1004 is fluidly coupled to the body 1903 of each perforated structure 1002. In the implementation of FIG. 5, the feed structure 1004 is fluidly coupled directly to the body 1903 of each perforated structure 1002, such that the CO₂ capture solution 114 flows from the feed structure 1004 directly to the inner volumes 1902 of the perforated structures 1002. In other implementations, an example of which is described below, the feed structure 1004 is indirectly coupled to the perforated structures 1002. The feed structure 1004 includes one or more feed pipes or feed conduits 1005. The feed conduit 1005 is an elongated, at least partially hollow body with one or more walls that enclose a feed conduit inner volume 1011. The feed conduit inner volume 1011 is in fluid communication with the inner volumes 1902 of each body 1903 via one or more conduit openings 1013 in the walls of the feed conduit 1005. The feed conduit 1005 is configured to feed the CO₂ capture solution 114 to each perforated structure 1002 sequentially (e.g., by filling one perforated structure 1002 completely before filling the next perforated structure 1002) or simultaneously (e.g., by filling all the perforated structures 1002 at substantially the same time). The feed conduit 1005 is in fluid communication with one or more features of the liquid distribution system 120, such as one or more of the basins 109, pipes, and pump(s) 122 to receive the CO₂ capture solution 114 before flowing the CO₂ capture solution 114 to the perforated structures 1002.

In the feed structure 1004 of FIG. 5, the feed conduit 1005 is a solid body that does not form a liquid film 1007 of the CO₂ capture solution 114 along its outer surface. In other configurations of the feed structure 4004, an example of which is shown in FIG. 9, the one or more feed conduits 4005 are at least partially perforated. Referring to FIG. 9, the feed conduit 4005 has a horizontal orientation and feed conduit perforations 4007 that extend through at least a lower portion of the feed conduit 4005. Such a perforated feed conduit 4005 allows the CO₂ capture solution 114 to flow or seep through the feed conduit 4005 to form the liquid film 1007 on the horizontally extending exterior surface of the feed conduit 4005, thereby providing more wetted surface area between the perforated structures 1002 which can participate in absorbing CO₂ from the CO₂-laden air 101. If desired, the feed conduit perforations 4007 may also be present on an upper portion of the feed conduit 4005.

Referring to FIG. 5, the feed conduit 1005 is an elongated body that defines a feed conduit axis 1015. The perforated structures 1002 are coupled to feed conduit 1005 at a nonparallel angle. The feed conduit axis 1015 is transverse to the longitudinal axes 1901 of each of the perforated structures 1002. By “transverse”, it is understood that the feed conduit axis 1015 is perpendicular to a first plane, and the longitudinal axes 1901 are perpendicular to a second plane that intersects and is non-parallel to the first plane. In the perforated packing 1000 of FIG. 5, the first and second planes are perpendicular to one another, such that the perforated structures 1002 are perpendicular to the feed conduit 1005. The CO₂ capture solution 144 is thus flowed through the feed conduit 1005 along a first direction, and then flowed within the perforated structures 1002 along a second direction that is transverse to the first direction. The CO₂ capture solution 114 flows within the perforated structures 1002 along a liquid direction that is transverse to the flow direction, D. In another possible configuration of the relationship between the feed conduit 1005 and the perforated structures 1002, the feed conduit and longitudinal axes 1015, 1901 are parallel, and the feed conduit 1005 has branched extremities which feed the perforated structures 1002. Referring to FIG. 5, each perforated structure 1002 is spaced apart from an adjacent perforated structure 1002 in a direction parallel to the feed conduit axis 1015. Similarly, inlets 1017 of the perforated structures 1002, which are fluidly coupled to the feed conduit inner volume 1011, are spaced apart from one another in a direction parallel to the feed conduit axis 1015. In the perforated packing 1000 of FIG. 5, the end of each perforated structure 1002 that is opposite to its inlet 1017 is closed, so that the CO₂ capture solution 114 can fill the inner volume 1902 of each perforated structure 1002 and generate the hydrostatic pressure required for the CO₂ capture solution 114 to seep through the perforations 904 and onto the outer surface 1906. Flow or seepage of the CO₂ capture solution 114 through the perforations 904 may thus be driven by pressure differential. In other configurations of the perforated packing disclosed herein, an example of which is described below, the perforated structures are at least partially open at the ends opposite to their inlets. In the perforated packing 1000 of FIG. 5, the perforated structures 1002 have a vertical orientation and the perforations 904 are disposed beneath the inlets 1017 of the perforated structures 1002. The inlets 1017 are thus positioned directly above the perforations 904, and are vertically aligned with the perforations 904. The description and one, some, or all of the advantages, features and functions of the perforated structures 900, 5900 provided above apply mutatis mutandis to the perforated structures 1002 of FIG. 5.

FIG. 6 shows another example of a perforated packing 1100, which can make up some or all of the packing 106, 2106, 3106, 4106 used in the gas-liquid contactors 100, 100a, 100b, 100c disclosed herein. The perforated packing 1100 of FIG. 6 includes multiple perforated structures 1102. The description and one, some, or all of the advantages, features and functions of the perforated structures 900, 5900, 1002 provided above apply mutatis mutandis to the perforated structures 1102 of FIG. 6. The description and one, some, or all of the advantages, features and functions of the perforated packing 1000 provided above apply mutatis mutandis to the perforated packing 1100 of FIG. 6.

Referring to FIG. 6, the perforated structures 1102 are spaced apart from each other and form an arrangement 1109 of perforated structures 1102. In FIG. 6, the perforated structures 1102 are spaced apart in a direction that is perpendicular to the flow direction, D, of the CO₂-laden air 101 flowing through the perforated packing 1100, where the flow direction, D, is into the page of FIG. 6. The perforated structures 1102 may also be spaced apart from each other in other directions, such as in a direction that is parallel to the flow direction, D, (i.e., into the page of FIG. 6). The perforated structures 1102 are oriented horizontally. This orientation of the perforated structures 1102 allows the liquid film 1007 of CO₂ capture solution 114 to form along the outer surfaces 1106 of the perforated structures 1102 due to the pressure differential between the accumulated CO₂ capture solution 114 in the inner volumes 2902 and the outer surfaces 1106. The perforated structures 1102 are thus oriented so that the average flow direction of the CO2 capture solution 114 is along the longitudinal axes 2901 of the perforated structures 1102. In the configuration of the horizontally-oriented perforated structures 1102 of FIG. 6, the liquid film 1007 forms along upper, lower and side portions of the outer surfaces 1106 until sufficient CO₂ capture solution 114 accumulates on the lower portions of the outer surfaces 1106 to form droplets of a solution of CO₂ capture solution 114 and CO₂-laden capture solution 111. The liquid film 1007 eventually breaks along the lower portions of the outer surfaces 1106, and forms droplets of solution that are collected in the bottom basin 1110. The thickness of the liquid film 1007 may vary along the extent of the perforated structure 1102.

Referring to FIG. 6, the feed structure 1104 is fluidly coupled to the body 2903 of each perforated structure 1102. In the implementation of FIG. 6, the feed structure 1104 is fluidly coupled directly to the body 2903 of each perforated structure 1102, such that the CO₂ capture solution 114 flows from the feed structure 1104 directly to the inner volumes 2902 of the perforated structures 1102. The feed conduit 2005 is in fluid communication with one or more features of the liquid distribution system 120, such as one or more of the basins 109, pipes, and pump(s) 122 to receive the CO₂ capture solution 114 before flowing the CO₂ capture solution 114 to the perforated structures 1102.

Referring to FIG. 6, the perforated structures 1102 are coupled to the feed conduit 2005 at a nonparallel angle. The feed conduit axis 1115 is transverse to the longitudinal axes 2901 of each of the perforated structures 1102. In the perforated packing 1100 of FIG. 6, the perforated structures 1102 are perpendicular to the feed conduit 2005. Referring to FIG. 6, each perforated structure 1102 is spaced apart from an adjacent perforated structure 1102 in a direction parallel to the feed conduit axis 1115. In the perforated packing 1100 of FIG. 6, the end of each perforated structure 1102 that is opposite to its inlet 1128 is closed, so that the CO₂ capture solution 114 can fill the inner volume 2902 of each perforated structure 1102 and generate the hydrostatic pressure required for the CO₂ capture solution 114 to seep through the perforations 904 and onto the outer surface 1106. Flow or seepage of the CO₂ capture solution 114 through the perforations 904 may thus be driven by pressure differential. In the perforated packing 1100 of FIG. 6, the perforated structures 1102 have a horizontal orientation and the perforations 904 are spaced horizontally from the inlets 1128 of the perforated structures 1102. The perforations 904 are thus spaced horizontally apart from the feed conduit 2005.

Referring to FIG. 6, the feed conduit 2005 is configured to feed the CO₂ capture solution 114 to each perforated structure 1102. In steady state operation of the perforated packing 1100, the perforated structures 1102 are filled with the CO₂ capture solution 114 and generating the liquid film 1007 along the outer surfaces 1106. In initial, start-up or pulsed-flow operation of the perforated packing 1100, the perforated structures 1102 are filled with the CO₂ capture solution 114 simultaneously (e.g., by filling all the perforated structures 1102 at substantially the same time), sequentially (e.g., by at least partially filling one perforated structure 1102 before filling the next perforated structure 1102), or a combination of both. In the implementation of FIG. 6, the CO₂ capture solution 114 can be fed from the top of the feed structure 1104 (e.g., by gravity or pumped). In some implementations, the CO₂ capture solution 114 can be pumped from the bottom of the feed structure 1104. The CO₂ capture solution 114 can flow or drip from an upper perforated structure 1102 to a lower perforated structure 1102. This can be beneficial as a top portion of a lower perforated structure 1102 is wetted by dripping CO₂ capture solution 114, which may increase its wettability and thus its efficiency at capturing CO₂ from the CO₂-laden air 101.

Other configurations of the feed structure 1004, 1104 are possible. For example, in another possible configuration of the feed structure 1004, 1104, the feed structure 1004, 1104 has no feed conduits 1005. In such a configuration, the feed structure 1004, 1104 may be, or may include, a basin such as the top basin 104 or a fluid manifold. The perforated structures 1002, 1102 may be fluidly coupled directly to such a feed structure 1004, 1104 to receive the CO₂ capture solution 114. In another possible configuration of the feed structure 1004, 1104, the feed conduit 1005, 2005 feeds only some of the perforated structures 1002, 1102, and the CO₂ capture solution 114 flow from the fed perforated structures 1002, 1102 to the other perforated structures 1002, 1102. In some cases, the perforated structures 1002, 1102 are coupled to more than one feed structure 1004, 1104. In a possible configuration of the perforated packing 1000, 1100, the perforated structures 1002, 1102 are both vertically and horizontally-oriented. Although shown in some figures as cylindrical tubs, the perforated structures 900, 1002, 1102 and the feed structure 1004, 1104 can be in the form of plates, spheres, blocks, tubes, or a combination thereof.

The perforated packing 1000,1100 of FIGS. 5 and 6 can be implemented in a gas-liquid contactor 100, 100a, 100b, 100c disclosed herein in any one of a crossflow configuration, a cocurrent flow configuration, and a counter-flow configuration. In a crossflow configuration, the flow direction, D, of the CO₂-laden air 101 is substantially perpendicular to the direction at which the CO₂ capture solution 114 flows through the perforated packing 1000, 1100. In some cases, the perforated packing 1000, 1100 can be implemented in a counterflow configuration. In a counterflow configuration, the flow direction, D, of the CO₂-laden air 101 is substantially parallel to the direction at which the CO₂ capture solution 114 flows through the perforated packing 1000,1100, and the flow direction, D, is towards the feed structure 1004,1104. The structural integrity can be a consideration in overall design of the perforated packing 1000,1100 and can be influenced by numerous design factors, for example diameter(s) and length(s) of the perforated structures, material(s) of construction of the perforated structures, size(s) and arrangement and spacing of the perforations, and operating conditions (e.g., pressure, temperature). Structural integrity may also be influenced by the addition of supports or structural members. In some cases, nominal perforation diameter may be decreased and/or perforation spacing may be increased to improve structural stability.

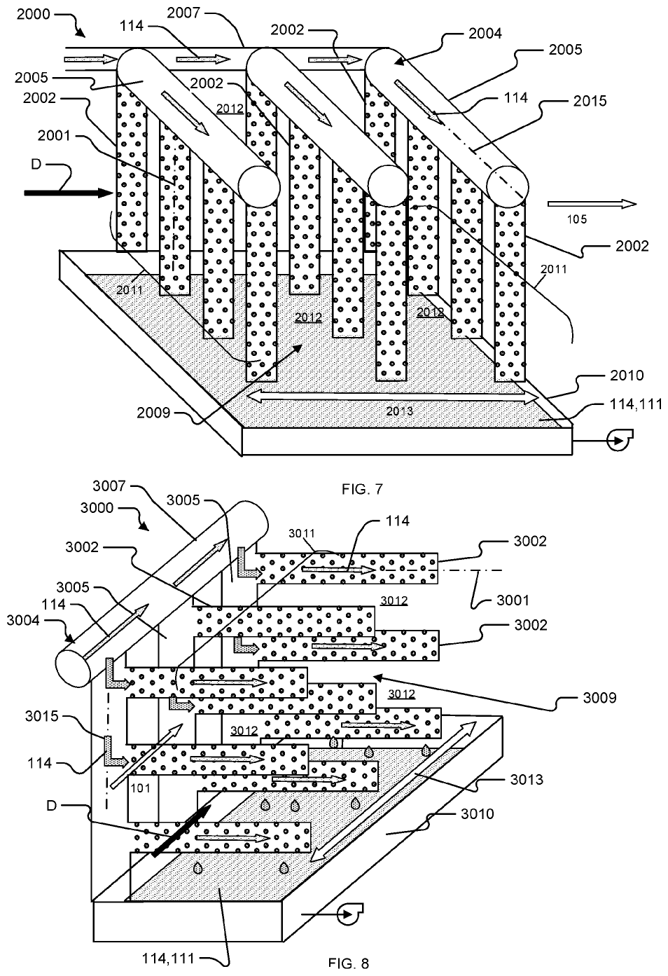

FIG. 7 shows another example of a perforated packing 2000, which can make up some or all of the packing 106, 2106, 3106, 4106 used in the gas-liquid contactors 100, 100a, 100b, 100c disclosed herein. The perforated packing 2000 of FIG. 7 includes multiple perforated structures 2002. The description and one, some, or all of the advantages, features and functions of the perforated structures 900, 5900, 1002, 1102 provided above apply mutatis mutandis to the perforated structures 2002 of FIG. 7. The description and one, some, or all of the advantages, features and functions of the perforated packing 1000, 1100 provided above apply mutatis mutandis to the perforated packing 2000 of FIG. 7.

Referring to FIG. 7, the perforated structures 2002 are spaced apart from each other and form an arrangement 2009 of perforated structures 2002. In FIG. 7, the perforated structures 2002 are spaced apart in a direction that is parallel to the flow direction, D, of the CO₂-laden air 101 flowing through the perforated packing 2000. The perforated structures 2002 are also spaced apart from each other in other directions, such as in a direction that is perpendicular to the flow direction, D (i.e. parallel to the feed conduit axes 2015 of the multiple feed conduits 2005 of the feed structure 2004). The perforated structures 2002 are oriented vertically, and positioned directly above the bottom basin 2010 of the gas-liquid contactor, so that the solution of CO₂ capture solution 114 and CO₂-laden capture solution 111 can be collected in the bottom basin 2010. The multiple feed conduits 2005 extend perpendicularly from a feed manifold 2007 of the feed structure 2004. Multiple perforated structures 2002 extend perpendicularly and vertically downwardly from each feed conduit 2005. The longitudinal axis 2001 of each perforated structure 2002 is transverse (e.g. perpendicular) to the flow direction, D, of the CO₂-laden air 101.

Referring to FIG. 7, the arrangement 2009 of the perforated structures 2002 includes rows 2011 of the perforated structures 2002. Each row 2011 contains multiple perforated structures 2002 fed by a single feed conduit 2005. The perforated structures 2002 in a row 2011 are spaced apart from one another in a direction that is parallel to the feed conduit axis 2015 of the feed conduit 2005 of the row 2011. The rows 2011 are spaced apart from one another in a direction that is parallel to the flow direction, D. The spacing of the rows 2011, and of the perforated structures 2002 within each row 2011, form the flow gaps 2012 between the perforated structures 2002 of the perforated packing 2000. A depth 2013 of the arrangement 2009 is measured in a direction parallel to the flow direction, D. The depth 2013 can vary. A non-limiting example of values for the depth 2013 is between 2 meters and 10 meters. The depth 2013 of the arrangement 2009 may be equal to or less than the air travel depth through the packing 106, 2106, 3106, 4106 (e.g., packing depth) in the gas-liquid contactors 100, 100a, 100b, 100c disclosed herein.

FIG. 8 shows another example of a perforated packing 3000, which can make up some or all of the packing 106, 2106, 3106, 4106 used in the gas-liquid contactors 100, 100a, 100b, 100c disclosed herein. The perforated packing 3000 of FIG. 8 includes multiple perforated structures 3002. The description and one, some, or all of the advantages, features and functions of the perforated structures 900, 5900, 1002, 1102, 2002 provided above apply mutatis mutandis to the perforated structures 3002 of FIG. 8. The description and one, some, or all of the advantages, features and functions of the perforated packing 1000, 1100, 2000 provided above apply mutatis mutandis to the perforated packing 3000 of FIG. 8.

Referring to FIG. 8, the perforated structures 3002 are spaced apart from each other and form an arrangement 3009 of perforated structures 3002. In FIG. 8, the perforated structures 3002 are spaced apart in a direction that is parallel to the flow direction, D, of the CO₂-laden air 101 flowing through the perforated packing 3000. The perforated structures 3002 are also spaced apart from each other in other directions, such as in a direction that is perpendicular to the flow direction, D (i.e., vertically in the page of FIG. 8, which is also parallel to the feed conduit axes 3015 of the multiple feed conduits 3005 of the feed structure 3004). The perforated structures 3002 are oriented horizontally, with some positioned above one or more other perforated structures 3002, and all positioned directly above the bottom basin 3010 of the gas-liquid contactor, so that the solution of CO₂ capture solution 114 and CO₂-laden capture solution 111 can be collected in the bottom basin 3010. The multiple feed conduits 3005 extend perpendicularly from a feed manifold 3007 of the feed structure 3004. Multiple perforated structures 3002 extend perpendicularly and horizontally from each feed conduit 3005. The longitudinal axis 3001 of each perforated structure 3002 is transverse (e.g. perpendicular) to the flow direction, D, of the CO₂-laden air 101.

Referring to FIG. 8, the arrangement 3009 of the perforated structures 3002 includes rows 3011 of the perforated structures 3002. In the perforated packing 3000 of FIG. 8, each row 3011 contains multiple perforated structures 3002 each of which is fed by a different feed conduit 3005. The rows 3011 are spaced apart from one another in a direction that is parallel to the feed conduit axes 3015 of the feed conduits 3005. The perforated structures 3002 in each row 3011 are spaced apart from one another in a direction that is parallel to the flow direction, D. The spacing of the rows 3011, and of the perforated structures 3002 within each row 3011, form the flow gaps 3012 between the perforated structures 3002 of the perforated packing 3000. A depth 3013 of the arrangement 3009 is measured in a direction parallel to the flow direction, D. The depth 3013 can vary. A non-limiting example of values for the depth 3013 is between 2 meters and 10 meters. The depth 3013 of the arrangement 3009 may be equal to or less than the air travel depth through the packing 106, 2106, 3106, 4106 (e.g., packing depth) in the gas-liquid contactors 100, 100a, 100b, 100c disclosed herein.

FIG. 11 shows another example of a perforated packing 6000, which can make up some or all of the packing 106, 2106, 3106, 4106 used in the gas-liquid contactors 100, 100a, 100b, 100c disclosed herein. The perforated packing 6000 of FIG. 11 includes multiple perforated structures 6002. The description and one, some, or all of the advantages, features and functions of the perforated structures 900, 5900, 1002, 1102, 2002, 3002 provided above apply mutatis mutandis to the perforated structures 6002 of FIG. 11. The description and one, some, or all of the advantages, features and functions of the perforated packing 1000, 1100, 2000, 3000 provided above apply mutatis mutandis to the perforated packing 6000 of FIG. 11.

Referring to FIG. 11, the perforated structures 6002 are spaced apart from each other and form an arrangement 6009 of perforated structures 6002. In FIG. 11, the perforated structures 6002 are spaced apart in a direction that is perpendicular to the flow direction, D, of the CO₂-laden air 101 flowing through the perforated packing 6000. In FIG. 11, the perforated structures 6002 are equally spaced apart in the direction that is perpendicular to the flow direction, D. In other possible implementations, the spacing between the perforated structures 6002 varies. The perforated structures 6002 are in the form of plates or blocks which have perforations 904 extending through one or more planar walls of the perforated structures 6002. A single feed conduit 6005 extends perpendicularly relative to the extent of the perforated structures 6002 defined along the flow direction, D.

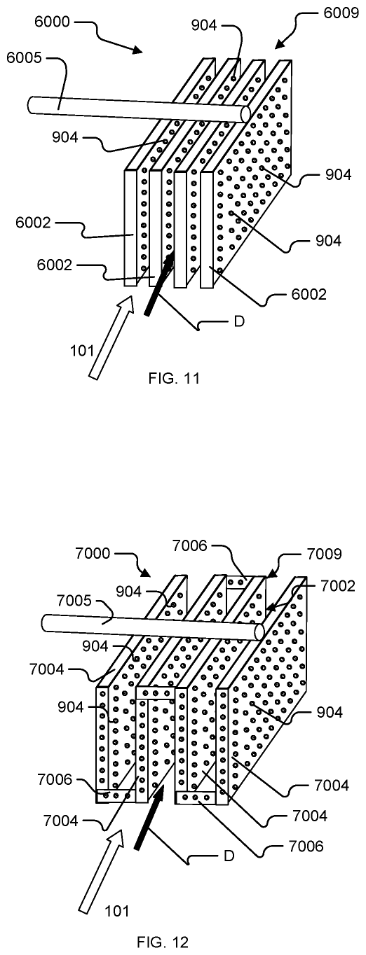

FIG. 12 shows another example of a perforated packing 7000, which can make up some or all of the packing 106, 2106, 3106, 4106 used in the gas-liquid contactors 100, 100a, 100b, 100c disclosed herein. The perforated packing 7000 of FIG. 12 includes a single perforated structure 7002. The description and one, some, or all of the advantages, features and functions of the perforated structures 900, 5900, 1002, 1102, 2002, 3002, 6002 provided above apply mutatis mutandis to the perforated structure 7002 of FIG. 12. The description and one, some, or all of the advantages, features and functions of the perforated packing 1000, 1100, 2000, 3000, 6000 provided above apply mutatis mutandis to the perforated packing 7000 of FIG. 12.

Referring to FIG. 12, the single perforated structure 7002 includes perforated structure segments 7004 which are interconnected by supports 7006. The perforated structure segments 7004 are spaced apart from each other and form an arrangement 7009 of the perforated structures 7002. In FIG. 12, the perforated structure segments 7004 are spaced apart in a direction that is perpendicular to the flow direction, D, of the CO₂-laden air 101 flowing through the perforated packing 7000. The perforated structure segments 7004 are in the form of plates or blocks which have perforations 904 extending through one or more planar walls of the perforated structure segments 7004. A single feed conduit 7005 extends perpendicularly relative to the extent of the perforated structure segments 7004 defined along the flow direction, D. The supports 7006 in the implementation of FIG. 12 have perforations 904 and thus contribute to the surface area of the perforated packing 7000 which can be wetted by the CO₂ capture solution 114 for mass transfer with the CO₂ from the CO₂-laden air 101. The supports 7006 may introduce more turbulence in the flow of the CO₂-laden air 101 through the perforated packing 7000, which may also improve mass transfer of the CO₂ from the CO₂-laden air 101 to the CO₂ capture solution 114.

The perforated packing, in at least some implementations, may allow for some or all mass transfer of CO₂ from the CO₂-laden air 101 to the CO₂ capture solution 114 to occur within the perforated structures. In some implementations, the dilute gas mixture is provided to the inner volumes of the perforated structures and the CO₂ capture solution 114 flows or seeps from outer surface into the inner volume through the perforations 904. In such implementations, CO₂ in the dilute gas mixture is transferred (e.g., absorbed) to the capture solution in the inner volume. In some implementations, the feed structure provides the CO₂-laden air 101 to the inner volume of the perforated structure. The CO₂ capture solution 114 can flow on the outer surface of the perforated structure and flow (e.g., seep) through the perforations 904 to form the liquid film on the inner surface of the perforated structures, where it contacts the second fluid CO₂-laden air 101. In such cases, the CO₂-lean gas 105 is yielded in the inner volume. The CO₂-lean gas 105 and CO₂ capture solution 114 can leave the inner volume of the perforated structure by, for example, being withdrawn through at least one outlet.

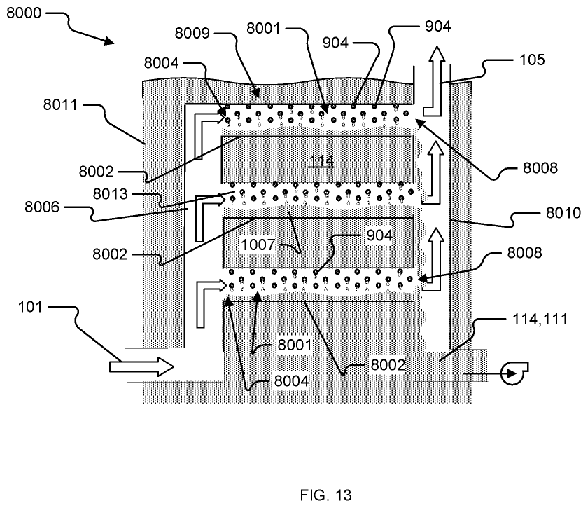

FIG. 13 provides an example of a perforated packing 8000 in which mass transfer of CO₂ from the CO₂-laden air 101 to the CO₂ capture solution 114 occurs within the perforated structures 8002. FIG. 13 shows another example of a perforated packing 8000, which can make up some or all of the packing 106, 2106, 3106, 4106 used in the gas-liquid contactors 100, 100a, 100b, 100c disclosed herein. The perforated packing 8000 of FIG. 13 includes multiple perforated structures 8002. The description and one, some, or all of the advantages, features and functions of the perforated structures 900, 5900, 1002, 1102, 2002, 3002, 6002, 7002 provided above apply mutatis mutandis to the perforated structure 8002 of FIG. 13. The description and one, some, or all of the advantages, features and functions of the perforated packing 1000, 1100, 2000, 3000, 6000, 7000 provided above apply mutatis mutandis to the perforated packing 8000 of FIG. 13.

Referring to FIG. 13, the perforated structures 8002 are spaced apart from each other and form an arrangement 8009 of perforated structures 8002. In FIG. 13, the perforated structures 8002 are submerged in a reservoir 8011 of CO₂ capture solution 114 and are thus immersed in the CO₂ capture solution 114. The reservoir 8011 may be a component of a feed structure of the perforated packing 8000. The perforated structures 8002 have a horizontal orientation, and extend from inlets 8004 in fluid communication with an air feed conduit 8006. The air feed conduit 8006 supplies the CO₂-laden air 101 to the perforated structures 8002. The perforated structures 8002 have outlets 8008 which are in fluid communication with an outlet conduit 8010. The perforated structures 8002 of FIG. 13 are open at both their ends. The outlet conduit 8010 helps to vent or discharge the CO₂-lean gas 105 to atmosphere, and also collects the solution of CO₂ capture solution 114 and CO₂-laden capture solution 111. The solution flows down the outlet conduit 810 to be processed as described above.

Referring to FIG. 13, the perforated structures 8002 are spaced apart in a vertical direction. The perforated structures 8002 have multiple perforations 904. The perforations 904 may be present along only an upper portion of the perforated structures 8002, such that the lower portions of the perforated structures 8002 are unperforated. Alternatively, both the upper and lower portions of the perforated structures 8002 may have perforations 904.

The pressure differential between the CO₂ capture solution 114 in the reservoir 8011 and the inner volumes 8001 of the perforated structures 8002 causes the CO₂ capture solution 114 to seep into the inner volumes 8001, forming a liquid film 1007 along an inner surface 8013 of the perforated structures 8002. The surface of the liquid film 1007 is a gas-liquid interface between the CO₂-laden air 101 flowing along the inner surfaces 8013 and the CO₂ capture solution 114. CO₂ from the CO₂-laden air 101 is absorbed into the liquid film 1007 to form a solution of CO₂ capture solution 114 and CO₂-laden capture solution 111, and to form the CO₂-lean gas 105 discharged from the outlet conduit 8010. The solution eventually flows through the inner volumes 8001 and into the outlet conduit 8010. The liquid level of CO₂ capture solution 114 within the reservoir 8011 may be selected to generate enough hydrostatic pressure to cause the CO₂ capture solution 114 to seep into the perforated structure 8002, but not enough to cause the perforated structures 8002 to collapse unto themselves. Thus, in the perforated packing 8000 of FIG. 13, the mass transfer of CO₂ from the CO₂-laden air 101 to the CO₂ capture solution 114 occurs within the perforated structures 8002.

The arrangement of perforated structures disclosed herein (such as arrangement 1009, 1109, 2009, 3009, 6009, 7009, and 8009) may position the perforated structures in any suitable configuration. Non-limiting examples include hexagonal, square, rectangular, triangular, circular, staggered, or a combination thereof of arrangements of the perforated structures.

The perforated structures (such as perforated structures 900,5900,1002,1102, 2002, 3002,6002,7002,8002 disclosed herein) can include structures on the wall defining the outer surfaces of the perforated structures, which may facilitate forming the liquid film 1007 of CO₂ capture solution 114 and increase the mass transfer area. These structures allow for adjusting the surface roughness, and can be used to adjust the contact angle of CO₂ capture solution 114 on the surface of the perforated structure to increase the wetted surface area. The shape of a surface of the perforated structures can be exploited to adjust the apparent contact angle θ_{A}.

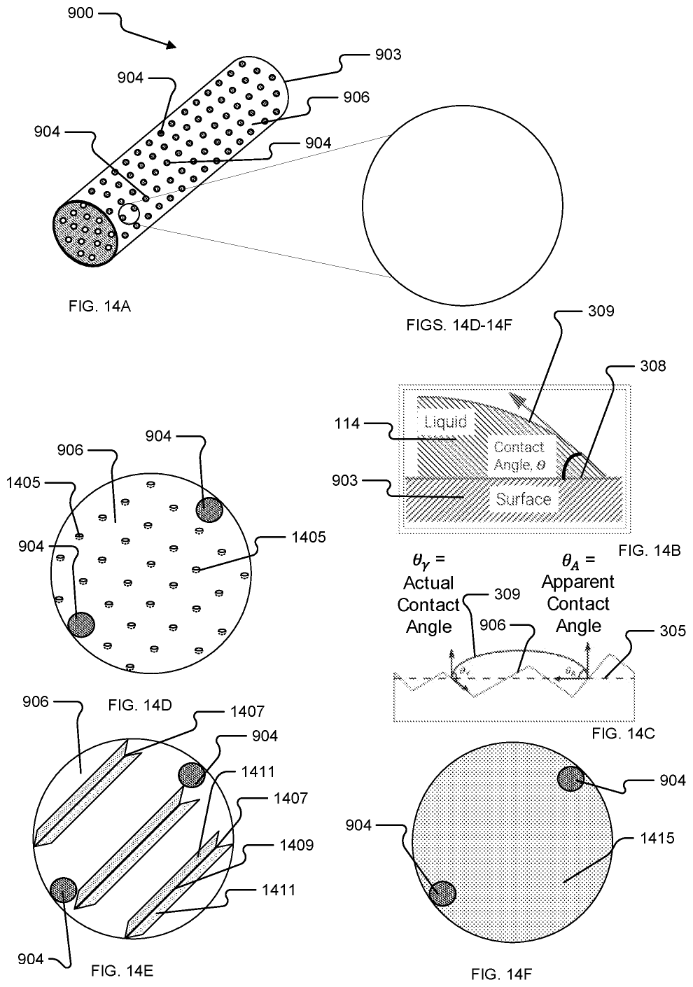

Poor wetting and hydrophobicity (e.g., tending to repel or not mix with liquid) are usually associated with a high contact angle θ. Contact angle θ is defined as the angle between the liquid-solid interface 308 and the liquid-gas interface 309, measured through the solution 114, as shown in FIG. 14B. The contact angle θ can affect the flow regime of the CO₂ capture solution 114 flowing on the surface of the perforated structure. For instance, a high contact angle θ (e.g., of greater than 70 degrees and less than 150 degrees) can result in rivulet flow along the surface and a low wetting fraction E (e.g., wetted surface area), which can reduce the gas-liquid interface area of the surface that is available for mass transfer from the CO₂-laden air 101 to the CO₂ capture solution 114. In contrast, a low contact angle θ (e.g., of greater than 20 degrees and less than 50 degrees) can result in liquid film flow along the surface of the perforated structure and a high wetting fraction E. Referring to FIG. 14C, the apparent contact angle θ_{A} is the angle between the apparent solid surface 305 (as opposed to the actual solid surface 906) and the liquid-gas interface 309. The actual contact angle θ_{γ} is the angle between the actual solid surface 906 and the liquid-gas interface 309.

The structures may affect the ‘macro’ flow of the CO₂ capture solution 114 over the surface, and may affect the contact angle θ of the CO₂ capture solution 114 on the surface. The structures may include patterns such as corrugations, tubes, flutes, herringbone, or channels that affect the tendency of the liquid film 1007 to move backward, forward, or straight along the outer surface depending on the air velocity and the rigidity of the perforated structure. The structures may be small-scale patterns or structures that can reduce the apparent contact angle θ_{A} and enable the liquid film 1007 to flow.

Referring to FIGS. 14A and 14D, the wall 903 of the perforated structure 900 includes multiple structures 1405. The structures 1405 may be disposed in any regular or irregular arrangement or pattern on the wall 903. The structures 1405 and the wall 903 collectively define the outer surface 906 of the perforated structure 900. Non-limiting examples of the structures 1405 include ridges, dimples, pores, etches, granules, or fibers. In some implementations, the perforated structure 900 can includes pores or is a porous material. The porous materials can be amorphous or non-uniform and includes grooves or depressions that can have a characteristic dimension (e.g., about 1 mm). A porous material can allow a larger liquid film 1007 to form by increasing the wettable surface area of the perforated structure 900.

The structures 1405 of the perforated structure 900 can be very small-scale features that improve wetting of the CO₂ capture solution 114 through the effect of the apparent contact angle θ_{A} (as opposed to the actual contact angle θ_{γ}). The size of the structures 1405 can be on the scale of millimeters. In configurations where the structures 1405 include ridges, these can be used to achieve a low apparent contact angle θ_{A}. In some implementations, the ridges can have widths of less than 10 mm. For example, the ridges can be sized between 1 mm to 2 mm. The ridges can be used to achieve better wetting by the CO₂ capture solution 114 in comparison to the surface 906 without these structures 1405.

Some structures 1405 can protrude from the wall 903. In some implementations, the structures 1405 protruding from the wall 903 can include a material that is different from the material of the wall 903. For example, the structures 1405 can include granules or fibres introduced to the wall 903 during manufacturing to increase the surface roughness of outer surface 906 that is initially smooth. Adding fibres to a perforated structure can achieve a texture that is similar to a fiberglass sheet. Some structures 1405 can depress into the wall 903. For example, the structures 1405 can include dimples, etches, pores, perforations, or combinations thereof that can be introduced to increase the surface roughness of the outer surface 906 that is initially smooth. The sizes, spacings, and shapes of these structures 1405 may be selected to lower the apparent contact angle θ_{A} (e.g., to 50 degrees or less) for liquid loading flow rates of CO₂ capture solution 114 ranging from, for example, 0 L/m²s to 10 L/m²s. In some cases, the structures 14054 are configured to lower the contact angle for low liquid loading rates ranging from 0.5 L/m²s to 2.5 L/m²s.

Referring to FIGS. 14A and 14E, the wall 903 of the perforated structure 900 includes multiple structures 1407. The wall 903 may be corrugated, or include structures to form a corrugated outer surface 906. For example, the structures 1407 may be ridges that form cross-sectional shapes having peaks 1409 and valleys 1411. Example structures 1407 include ridges having trapezoidal and/or triangular shapes. The ridges may form other cross-sectional shapes as well. Other examples of structures 1407 for the perforated structure 900 include channels or flutes. In some implementations, the structures 1407 can include dimensions which are larger than those of the structures 1405.

Referring to FIGS. 14A and 14F, the wall 903 of the perforated structure 900 includes a hydrophilic surface 1415. Since the wetted area of the surface 906 of the perforated structure 900 determines the amount of exposure of the CO₂ capture solution 114 to the CO₂ in the air, and a hydrophilic surface 1415 increases the wetted area for a given volume of the CO₂ capture solution 114, hydrophilic materials can be used for the surface 906 of the perforated structure 900. Hydrophilic coatings used to form the hydrophilic surface 1415, for example, increase surface energy and lower the contact angle. The hydrophilic surface 1415 may result from surface treatments that expose a material to change bonds on its surface can achieve similar results as well. By exhibiting hydrophilic properties rather than hydrophobic properties, the perforated structure may be able to increase contact between the liquid CO₂ capture solution 114 and the flow of CO₂-laden air 101 flow across the surface 906 of the perforated structure 900. Design criteria of the hydrophilic surface 1415 that reflect good performance can include but are not limited to: low static pressure design, ability to distribute liquid evenly throughout the extent of the perforated structure 900, low fouling capabilities, increase in air contacting efficiency, lower material requirements, and manufacturability. The hydrophilic surface 1415 may be formed by applying coatings, for example. Rather than or in addition to coatings, the hydrophilic surface 1415 can be formed by exposing the outer surface 906 to some surface treatments, which can lead to a change in bonds at the surface 906 to improve hydrophilicity. Examples of such surface treatments are plasma, flame, and corona treatments, and some chemical treatments with oxidizing agents. Some examples of surface treatments can be mechanical treatments, such as bead-blasting and embossing. A surface treatment can be applied directly to the outer surface 906. In some cases, a surface treatment can be applied to a coating that is on the outer surface 906, particularly if the coating is responsive to the surface treatment (e.g., contact angle is reduced and hydrophilic properties of the coating improve). Rather than or in addition to coatings and surface treatments, the hydrophilic surface 1415 may be formed from a material composition for the wall 903 selected to improve hydrophilicity. For example, a particular PVC resin and/or vinyl compound may have a higher surface energy and increased wettability than some thermoplastics (e.g., acrylic, polyester, polypropylene, polystyrene, nylon and Teflon™) that are used to form commercially available cooling tower packing.

The wall 903 of the perforated structure 900 may include structures 1405, structures 1407 and hydrophilic surfaces 1415, in any combination, to define the outer surface 906. For example, structures 1405 can be superimposed on structures 1407 to increase the wetted surface area. The perforated structure 900 may include larger shapes (an example of the structures 1407) that affect the tendency of the CO₂ capture solution 114 to flow in a particular direction, and structures 1405 to enable formation of the liquid film 1007 of the CO₂ capture solution 114. Thus, the structures 1407, the structures 1405, and/or hydrophilic coatings can be used independently or in combination with each other to increase the wetted surface area of perforated structure 900. Several structures 1407 and structures 1405 may be suitable to improving mass transfer for DAC applications where the CO₂ capture solution 114 is distributed at liquid loading flow rates ranging, for example, from 0 L/m²s to 10 L/m²s and distributed to perforated packing having a packing depth of, for example, 2-10 meters. In some cases, the structures 1407 and structures 1405 are suitable for liquid loading rates of 0.5 L/m²s to 2.5 L/m²s. In some cases, it can be advantageous to coat a surface of the perforated structure 900 with a rate-enhancing material that includes a rate-enhancing additive, for example a promoter or a catalyst, that is stabilized on a solid support by immobilization methods. For example, at least one of the structures 1405, structures 1407, or smooth surfaces of wall 903 can be coated with a rate-enhancing material.

The perforated structures disclosed herein (such as perforated structures 900, 5900, 1002, 1102, 2002, 3002, 6002, 7002, 8002) may be constructed from a rigid material. In some implementations, the perforated structures can comprise PVC, polyethylene, ceramic, metal, plastic, steel, or a combination thereof. Similarly, the feed structure and its features may be made from a rigid material such as PVC, polyethylene, ceramic, metal, plastic, steel, or a combination thereof. In other implementations, the perforated structures disclosed herein (such as perforated structures 900, 5900, 1002, 1102, 2002, 3002, 6002, 7002, 8002) may be flexible or resilient. The perforated structures may include a flexible material that allows them to deform in response to CO₂ capture solution 114 and the flow of CO₂-laden air 101. In one implementation, the bodies of the perforated structures are expandable, such that they expand and become rigid when filled with the CO₂ capture solution 114, and deflate and become flexible when emptied of the CO₂ capture solution 114. In other implementations, the perforated structures disclosed herein (such as perforated structures 900,5900,1002,1102, 2002, 3002,6002,7002,8002) are porous materials, such as sponge-like materials, which allow the CO₂ capture solution 114 to flow through the perforations 904 due at least in part to capillary action.

Referring to FIG. 15, the gas-liquid contactor 100, 100a, 100b, 100c with the perforated packing 1000,1100, 2000, 3000,6000,7000,8000 disclosed herein is part of a direct-air-capture (DAC) system 1200 for capturing CO₂ directly from atmospheric air, according to one possible and non-limiting example of a use for the gas-liquid contactor 100, 100a, 100b, and 100c. The gas-liquid contactor 100, 100a, 100b, 100c absorbs some of the CO₂ from the atmospheric air 1202 using the CO₂ capture solution 114 to form a CO₂ rich solution 1208. The CO₂ capture solution 114 may need to be regenerated from the CO₂-rich capture solution 1208, which can be carried out in a regeneration system 1230 of the DAC system 1200. The regeneration system 1230 functions to process the CO₂-rich capture solution 1208 (e.g., spent capture solution) to recover and/or concentrate the CO₂ content laden in the CO₂-rich capture solution 1208.

The CO₂ rich solution 1208 (e.g. the CO₂-laden capture solution 111) flows from the gas-liquid contactor 100, 100a, 100b, 100c to a pellet reactor 1210 of the DAC system 1200. A slurry of calcium hydroxide 1224 is injected into the pellet reactor 1210. A reaction between the CO₂ rich solution 1208 and the calcium hydroxide 1224 occurs in the pellet reactor. Ca reacts with CO₃²⁻ in the pellet reactor 1210 to form calcium carbonate solids and an aqueous alkaline solution as the CO₂ capture solution 114 (such as hydroxide), thereby regenerating the CO₂ capture solution 114. For example, potassium carbonate in the CO₂-rich solution 1208 can react with calcium hydroxide to form calcium carbonate and potassium hydroxide, thereby regenerating the CO₂ capture solution 114 that includes potassium hydroxide.

The reaction of the CO₂-rich solution with Ca(OH)2 causes precipitation of calcium carbonate (CaCO₃) onto calcium carbonate particles in the pellet reactor 1210. Further processing of the calcium carbonate solids, including but not limited to filtering, dewatering or drying, may occur prior to sending the calcium carbonate solids to downstream process units. A stream 1214 of calcium carbonate solids is transported from the pellet reactor 1210 to a calciner 1216 of the DAC system 1200. The calciner 1216 calcines the calcium carbonate of the stream 1214 from the pellet reactor 1210 to produce a stream of gaseous CO₂ 1218 and a stream of calcium oxide (CaO) 1220, possibly by oxy-combustion of a fuel source in the calciner 1216. The stream of gaseous CO₂ 1220 is processed for sequestration or other uses, thereby removing some of the CO₂ from the atmospheric air 1202 processed in the gas-liquid contactor 100, 100a, 100b, 100c. The stream of calcium oxide (CaO) 1220 is slaked with water in a slaker 1222 of the DAC system 1200 to produce the slurry of calcium hydroxide 1224 that is provided to the pellet reactor 1210. The DAC system 1200 may include multiple gas-liquid contactors 100, 100a, 100b, 100c, where each gas-liquid contactor 100, 100a, 100b, 100c forms a cell of a train/assembly of gas-liquid contactors 100, 100a, 100b, 100c.

In some implementations, the CO₂ capture solution 114 may be regenerated using a different regeneration system. The regeneration system 1230 may be part of the gas-liquid contactor 100, 100a, 100b, 100c or separate therefrom. In an example regeneration system 1230, the CO₂-rich solution 1208 may flow to an electrochemical system that includes a cell stack, which may include a set of one or more membranes, and a set of electrodes. The electrochemical system can regenerate the CO₂ capture solution 114 from CO₂-rich solution 1208 by applying an electric potential to an electrolyte including the CO₂-rich solution 1208. The difference in electric potential causes ion exchange, thereby forming the recovered CO₂ 1218 and regenerating the CO₂ capture solution 114. In an example regeneration system 1230, the CO₂ rich solution 1208 may flow to a thermal stripping column that employs steam to desorb CO₂ from the CO₂ rich solution 1208, thereby forming the recovered CO₂ stream 1218 and regenerating the CO₂ capture solution (e.g., CO₂-lean liquid).

The regeneration system 1230 can include liquid distribution pipes, solids conveying equipment, filtration systems, intermediate components like storage vessels, and/or an assembly of components which function cooperatively to regenerate the CO₂ capture solution 114. The regeneration system 1230 also includes pumps which flow liquids to and from the regeneration system 1230.

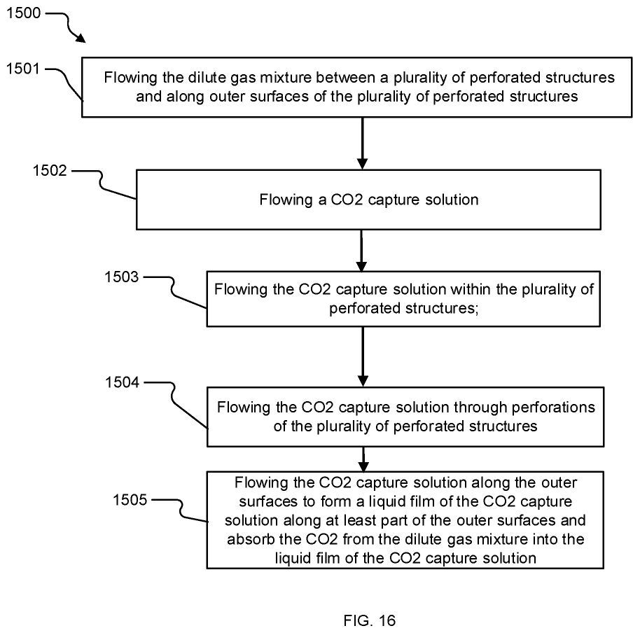

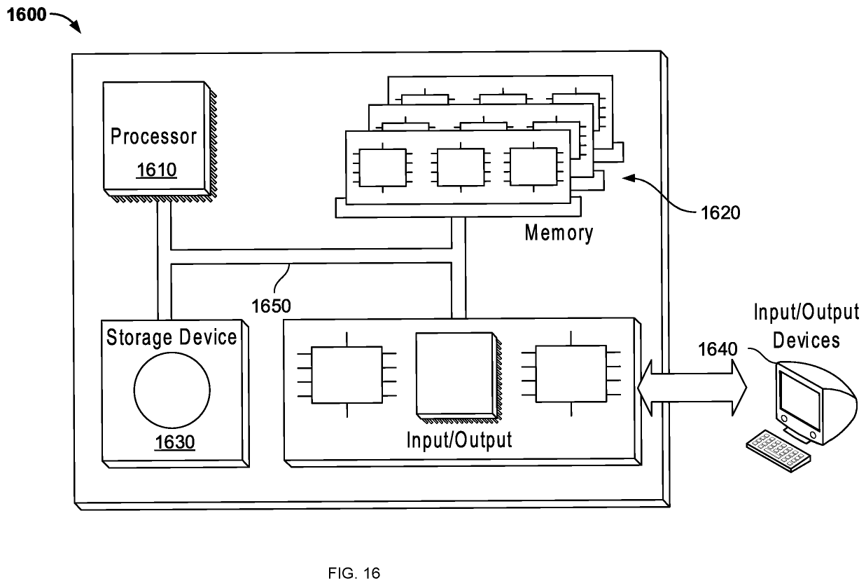

Referring to FIG. 16, a method 1500 for capturing carbon dioxide (CO₂) from a dilute gas mixture is disclosed. At 1501, the method 1500 includes flowing the dilute gas mixture (e.g. the CO₂-laden air 101) between a plurality of perforated structures (e.g. perforated structures 900,5900,1002,1102, 2002, 3002,6002,7002,8002) and along outer surfaces 906 of the perforated structures. At 1502, the method 1500 includes flowing the CO₂ capture solution 114. Flowing the CO₂ capture solution 114 at 1502 includes, at 1503, flowing the CO₂ capture solution 114 within the perforated structures. Flowing the CO₂ capture solution 114 at 1502 includes, at 1504, flowing the CO₂ capture solution 114 through perforations 904 of the perforated structures. Flowing the CO₂ capture solution 114 at 1502 includes, at 1505, flowing the CO₂ capture solution 114 along the outer surfaces 906 to form a liquid film 1007 of the CO₂ capture solution 114 along at least part of the outer surfaces 906, and to absorb the CO₂ from the dilute gas mixture into the liquid film 1007 of the CO₂ capture solution 114.

FIG. 17 is a schematic diagram of a control system (or controller) 1600 for a gas-liquid contactor, such as gas-liquid contactor 100, 100a, 100b, 100c disclosed herein. The system 1600 can be used for the operations described in association with any of the computer-implemented methods described previously, for example as or as part of the control system 999 or other controllers described herein.

The system 1600 is intended to include various forms of digital computers, such as laptops, desktops, workstations, personal digital assistants, servers, blade servers, mainframes, and other appropriate computers. The system 1600 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1600 includes a processor 1610, a memory 1620, a storage device 1630, and an input/output device 1640. Each of the components 1610, 1620, 1630, and 1640 are interconnected using a system bus 1650. The processor 1610 is capable of processing instructions for execution within the system 1600. The processor may be designed using any of a number of architectures. For example, the processor 1610 may be a CISC (Complex Instruction Set Computers) processor, a RISC (Reduced Instruction Set Computer) processor, or a MISC (Minimal Instruction Set Computer) processor.

In one implementation, the processor 1610 is a single-threaded processor. In some implementations, the processor 1610 is a multi-threaded processor. The processor 1610 is capable of processing instructions stored in the memory 1620 or on the storage device 1630 to display graphical information for a user interface on the input/output device 1640.

The memory 1620 stores information within the system 1600. In one implementation, the memory 1620 is a computer-readable medium. In one implementation, the memory 1620 is a volatile memory unit. In some implementations, the memory 1620 is a non-volatile memory unit.

The storage device 1630 is capable of providing mass storage for the system 1600. In one implementation, the storage device 1630 is a computer-readable medium. In various different implementations, the storage device 1630 may be a floppy disk device, a hard disk device, an optical disk device, or a tape device.

The input/output device 1640 provides input/output operations for the system 1600. In one implementation, the input/output device 1640 includes a keyboard and/or pointing device. In some implementations, the input/output device 1640 includes a display unit for displaying graphical user interfaces.

Certain features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

A number of embodiments of the disclosure have been described. Nevertheless, it will be understood that various modifications may be made without departing from the spirit and scope of the disclosure. Accordingly, other embodiments are within the scope of the following claims. Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

1. A perforated packing for capturing carbon dioxide (CO₂) from a dilute gas mixture, the perforated packing comprising:
at least one perforated structure comprising:
a body comprising:
at least one wall defining an inner volume of the body and an outer surface exposed to the dilute gas mixture; and
a plurality of perforations extending through the at least one wall between the inner volume and the outer surface; and
a feed structure fluidly coupled to the body and operable to flow a CO₂ capture solution into the inner volume of the body, through the plurality of perforations, and along the outer surface to form a liquid film of the CO₂ capture solution along at least part of the outer surface, the liquid film of the CO₂ capture solution configured to absorb CO₂ from the dilute gas mixture.

2. The perforated packing of claim 1, wherein the feed structure comprises at least one feed conduit defining a feed conduit inner volume fluidly coupled to the body.

3. The perforated packing of claim 2, wherein the at least one feed conduit comprises at least one conduit opening, the feed conduit inner volume fluidly coupled to the inner volume of the body by the at least one conduit opening.

4. The perforated packing of claim 2, wherein the body extends along a longitudinal axis, and the at least one feed conduit extends along a feed conduit axis transverse to the longitudinal axis.

5. The perforated packing of claim 4, wherein:
the at least one perforated structure comprises a plurality of perforated structures; and
a body of each perforated structure of the plurality of perforated structures having an inlet fluidly coupled to the feed conduit inner volume, the inlets of the plurality of perforated structures spaced apart in a direction parallel to the feed conduit axis.

6. The perforated packing of claim 5, wherein the plurality of perforations of each of the plurality of perforated structures are disposed beneath the inlet of the respective perforated structure.

7. The perforated packing of claim 2, wherein the at least one feed conduit has a horizontal orientation, the at least one feed conduit comprising a plurality of feed conduit perforations extending through at least a lower portion of the at least one feed conduit.

8. The perforated packing of claim 2, wherein the at least one feed conduit has a horizontal orientation, and the at least one perforated structure extends vertically downward from the at least one feed conduit.

9. The perforated packing of claim 2, wherein the at least one feed conduit has a vertical orientation, the at least one perforated structure extending horizontally from the at least one feed conduit.

10. The perforated packing of claim 1, wherein a distance between adjacent perforations of the plurality of perforations is greater than 2 times a diameter of each of the plurality of perforations and less than 10 times a diameter of each of the plurality of perforations.

11. The perforated packing of claim 1, wherein the at least one perforated structure is coupled to the feed structure at a nonparallel angle.

12. The perforated packing of claim 1, wherein the plurality of perforations are disposed along an entire length of the at least one wall.

13. The perforated packing of claim 1, wherein each perforation of the plurality of perforations has a largest dimension of less than 1.5 mm.

14. The perforated packing of claim 1, wherein at least some of the plurality of perforations are arranged on the at least one wall to form a shape comprising a hexagon, square, rectangle, triangle, or circle.

15. The perforated packing of claim 1, wherein the at least one perforated structure includes a plurality of perforated structures, the plurality of perforated structures forming an arrangement that is at least one of a hexagonal arrangement, a square arrangement, a rectangular arrangement, a triangular arrangement, or a circular arrangement.

16. The perforated packing of claim 1, wherein:
the body extends along a longitudinal axis; and
a cross-sectional shape of the body defined in a plane perpendicular to the longitudinal axis is rounded.

17. The perforated packing of claim 1, wherein the at least one perforated structure comprises at least one of tubes, plates, spheres, or blocks.

18. The perforated packing of claim 1, wherein the outer surface of the at least one wall is defined by a plurality of structures comprising at least one of ridges, dimples, pores, etches, granules, or fibers.

19. The perforated packing of claim 1, wherein the outer surface of the at least one wall comprises a hydrophilic surface.

20. The perforated packing of claim 1, wherein the at least one perforated structure includes a plurality of perforated structures being spaced apart from one another to define a plurality of flow gaps for the dilute gas mixture between each body of the plurality of perforated structures.

21. The perforated packing of claim 1, wherein the body of the at least one perforated structure is rigid.

22. The perforated packing of claim 1, wherein the body of the at least one perforated structure is resilient.

23. A gas-liquid contactor for capturing carbon dioxide (CO₂) from ambient air, the gas-liquid contactor comprising:
at least one inlet;
at least one outlet spaced apart from the at least one inlet;
at least one perforated packing disposed between the at least one inlet and the at least one outlet, the at least one perforated packing comprising a plurality of perforated structures spaced apart from each other, each perforated structure of the plurality of perforated structures comprising:
at least one wall defining an inner volume and an outer surface; and
a plurality of perforations extending through the at least one wall;
one or more basins including a bottom basin positioned at least partially below the at least one perforated packing, the one or more basins configured to hold a CO₂ capture solution;
a fan operable to flow the ambient air (1) in a flow direction from the at least one inlet to the at least one outlet and (2) along the outer surface of each of the plurality of perforated structures; and
a liquid distribution system fluidly coupled to at least one of the plurality of perforated structures and operable to flow the CO₂ capture solution into the inner volume of at least one of the plurality of perforated structures, through the plurality of perforations of at least one of the plurality of perforated structures, and along the outer surface of at least one of the plurality of perforated structures, to form a liquid film of the CO₂ capture solution along at least part of the outer surface of the at least one of the plurality of perforated structures, the liquid film of the CO₂ capture solution configured to absorb CO₂ from the ambient air.

24. The gas-liquid contactor of claim 23, wherein each perforated structure extends along a longitudinal axis transverse to the flow direction of the ambient air.

25. The gas-liquid contactor of claim 23, further comprising a housing defining an interior at least partially exposed to the ambient air and disposed between the at least one inlet and the at least one outlet, the plurality of perforated structures spaced apart within the interior and forming an arrangement of perforated structures that is at least one of a hexagonal arrangement, a square arrangement, a rectangular arrangement, a triangular arrangement, or a circular arrangement.

26. The gas-liquid contactor of claim 25, wherein the arrangement of perforated structures includes a plurality of rows of perforated structures spaced apart in a direction parallel to the flow direction.

27. The gas-liquid contactor of claim 25, wherein the arrangement of perforated structures has a depth measured in a direction parallel to the flow direction, the depth being between 2 meters and 10 meters.

28. A method for capturing carbon dioxide (CO₂) from a dilute gas mixture, the method comprising:
flowing the dilute gas mixture between a plurality of perforated structures and along an outer surface of at least one of the plurality of perforated structures; and
flowing a CO₂ capture solution within at least one of the plurality of perforated structures, through perforations of at least one of the plurality of perforated structures, and along the outer surface of at least one of the plurality of perforated structures to form a liquid film of the CO₂ capture solution along at least part of the outer surface of the at least one of the plurality of perforated structures and absorb the CO₂ from the dilute gas mixture into the liquid film of the CO₂ capture solution.

29.-40. (canceled)
